(19) United States
(12) Patent Application Publication
(10) Pub. No.: US 2007/0157261 A1
(43) Pub. Date: Jul. 5, 2007

(54) Digital media management system and method

(76) Inventors: Ryan Steelberg, Irvine, CA (US); Chad Steelberg, Newport Beach, CA (US)

Correspondence Address: GOOGLE / FENWICK, SILICON VALLEY CENTER, 801 CALIFORNIA ST., MOUNTAIN VIEW, CA, 94041, US

(21) Appl. No.: 11/305,891

(22) Filed: Dec. 15, 2005

(51) Int. Cl. H04N 7/173

(52) U.S. Cl. 725/87

(57) ABSTRACT

The present invention provides a system for managing broadcasting of media content. The system includes at least one database at a hub, wherein at least one digital file associated with the media content is relationally present in the at least one database, and a computer software accessible at a local media play point remote from the hub that provides a graphical user interface for at least scheduling, editing, and distributing of a plurality of ones of the at least one digital file for broadcasting, where the interface includes at least a header reader that allows for graphical display of header information, wherein the header information includes at least a graphic indicative of length of play and a plurality of alerts occurring within the length of play. Also included is at least one computerized device at the local media play point for accessing and playing the at least one digital file.

### RELATED APPLICATIONS

This application is related to U.S. patent application Ser. No. 11/131,022, the entire disclosure of which is incorporated by reference herein as if being set forth in its entirety.

### FIELD OF THE INVENTION

The invention relates to digital media systems, and, more particularly, to a computerized media broadcasting platform for providing real-time access to airtime scheduling from both local and remote locations.

### BACKGROUND OF THE INVENTION

Through the advancements of personal computing hardware, software and their interconnectivity through advanced networks, the evolution of radio broadcasting technology has moved in favor of automated systems. However, the beginning stages of this movement were far from desirous. For example, these systems were highly mechanical in nature, where they relied on tape-based playback devices that were tied to primitive computer sequencers. They were highly susceptible to technical problems, such as misaligned heads, faulty capstans and rollers, damaged tapes, and radio frequency interference. As can be imagined, this model lead to significant repair and replacement costs, and brought into question whether such a system was truly advantageous over preexisting broadcasting models.

In response to these initial problems, digital formats emerged as a better standard for audio content. Some systems were built for personal computers, while other systems created proprietary hardware and software systems. While these systems were better than the tape-based models, the inefficiencies of primitive operating systems and weak processing power resulted in lags and broadcasting failures, leaving live air-time with periodic programming misfires and silent gaps. Further, software systems lacked the comprehensive coverage needed for high-level or professional broadcasting. As with most automated radio systems, a user must purchase and run separate music selection and traffic software, which requires the merging of logs and playlists. As a result, these systems require multiple plug-ins, which lead to compatibility issues and lacked any sense of a “user-friendly” single interface.

Additionally, through the introduction and improvement of broad-band and satellite networking, radio's traditional role as an isolated radio frequency broadcast quickly ended. The demand for radio stations expanded to venues such as the Internet and phone line systems, for example, when a caller is waiting “on-hold”. Further to this, advancements not only in audio formats but video as well has created a need for a comprehensive digital multimedia broadcasting platform. Also, because networking infrastructures have become highly stable and reliable, budgets can be stream-lined through multiple automated broadcasting stations can be reviewed and controlled from remote locations.

Thus, a need exists for a single software platform for handling digital multimedia broadcasting in a variety of broadcasting mediums, where management of a large geographical area can be accomplished on-site as well as from a remote location.

### SUMMARY OF THE INVENTION

A system for managing broadcasting of media content is described. The system includes at least one database at a hub, wherein at least one digital file associated with the media content is relationally present in the at least one database, a computer software accessible at a local media play point remote from the hub that provides a graphical user interface for at least scheduling, editing, and distributing of a plurality of ones of the at least one digital file for said broadcasting, wherein the interface comprises at least a header reader that allows for graphical display of header information, wherein the header information includes at least a graphic indicative of length of play and a plurality of alerts occurring within the length of play, and at least one computerized device at the local media play point capable of accessing the at least one digital file based on instructions entered to the computer software via the graphical user interface for play over the local media play point.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts:

FIG. 1 illustrates an architecture of a communication system 100 according to an aspect of the present invention;

FIG. 2 further illustrates the system of FIG. 1;

FIG. 3 illustrates a local proxy according to an aspect of the present invention;

FIG. 4 is a screenshot illustrative of an exemplary embodiment of the present invention;

FIG. 5 is a screenshot illustrative of an exemplary embodiment of the present invention;

FIG. 6 is a screenshot illustrative of an exemplary embodiment of the present invention;

FIG. 7 is a screenshot illustrative of an exemplary embodiment of the present invention;

FIG. 8 is a screenshot illustrative of an exemplary embodiment of the present invention;

FIG. 9 is a screenshot illustrative of an exemplary embodiment of the present invention;

FIG. 10 is a screenshot illustrative of an exemplary embodiment of the present invention;

FIG. 11 is a screenshot illustrative of an exemplary embodiment of the present invention;

FIG. 12 is a screenshot illustrative of an exemplary embodiment of the present invention;

FIG. 13 is a screenshot illustrative of an exemplary embodiment of the present invention;

FIG. 14 is a screenshot illustrative of an exemplary embodiment of the present invention;

FIG. 15 is a screenshot illustrative of an exemplary embodiment of the present invention;

FIG. 16 is a screenshot illustrative of an exemplary embodiment of the present invention;

FIG. 17 is a screenshot illustrative of an exemplary embodiment of the present invention;

FIG. 18 is a screenshot illustrative of an exemplary embodiment of the present invention;

FIG. 19 is a screenshot illustrative of an exemplary embodiment of the present invention;

FIG. 20 is a screenshot illustrative of an exemplary embodiment of the present invention;

FIG. 21 is a screenshot illustrative of an exemplary embodiment of the present invention;

FIG. 22 is a screenshot illustrative of an exemplary embodiment of the present invention;

FIG. 23 is a screenshot illustrative of an exemplary embodiment of the present invention;

FIG. 24 is a screenshot illustrative of an exemplary embodiment of the present invention;

FIG. 25 is a screenshot illustrative of an exemplary embodiment of the present invention;

FIG. 26 is a screenshot illustrative of an exemplary embodiment of the present invention;

FIG. 27 is a screenshot illustrative of an exemplary embodiment of the present invention;

FIG. 28 is a screenshot illustrative of an exemplary embodiment of the present invention;

FIG. 29 is a screenshot illustrative of an exemplary embodiment of the present invention;

FIG. 30 is a screenshot illustrative of an exemplary embodiment of the present invention;

FIG. 31 is a screenshot illustrative of an exemplary embodiment of the present invention;

FIG. 32 is a screenshot illustrative of an exemplary embodiment of the present invention;

FIG. 33 is a screenshot illustrative of an exemplary embodiment of the present invention;

FIG. 34 is a screenshot illustrative of an exemplary embodiment of the present invention;

FIG. 35 is a screenshot illustrative of an exemplary embodiment of the present invention;

FIG. 36 is a screenshot illustrative of an exemplary embodiment of the present invention;

FIG. 37 is a screenshot illustrative of an exemplary embodiment of the present invention;

FIG. 38 is a screenshot illustrative of an exemplary embodiment of the present invention;

FIG. 39 is a screenshot illustrative of an exemplary embodiment of the present invention;

FIG. 40 is a screenshot illustrative of an exemplary embodiment of the present invention;

FIG. 41 is a screenshot illustrative of an exemplary embodiment of the present invention;

FIG. 42 is a screenshot illustrative of an exemplary embodiment of the present invention;

FIG. 43 is a screenshot illustrative of an exemplary embodiment of the present invention;

FIG. 44 is a screenshot illustrative of an exemplary embodiment of the present invention;

FIG. 45 is a screenshot illustrative of an exemplary embodiment of the present invention;

FIG. 46 is a screenshot illustrative of an exemplary embodiment of the present invention;

FIG. 47 is a screenshot illustrative of an exemplary embodiment of the present invention;

FIG. 48 is a screenshot illustrative of an exemplary embodiment of the present invention;

FIG. 49 is a screenshot illustrative of an exemplary embodiment of the present invention;

FIG. 50 is a screenshot illustrative of an exemplary embodiment of the present invention;

FIG. 51 is a screenshot illustrative of an exemplary embodiment of the present invention;

FIG. 52 is a screenshot illustrative of an exemplary embodiment of the present invention;

FIG. 53 is a screenshot illustrative of an exemplary embodiment of the present invention; and

FIG. 54 is a screenshot illustrative of an exemplary embodiment of the present invention.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in digital media management systems. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

The present invention provides a system for managing digital multimeda, including hardware, software and networking necessary for a broadcasting platform, all in a format that may be compatible with existing production editors, traffic systems, and music schedulers. Additionally, the present invention provides an efficient and easy to use graphical user interface that may display all or any portion of a library of digital files entered into the system allow a user to add, drop and edit files merely seconds before live airtime. For example, the system may provide a radio station or production studio the ability to schedule songs, promotions and spots, in a digital file format, in real time. Once the scheduled files or events have been entered, the list may be played manually by an active user, such as a disc jockey, announcer, or station manager, or it may run automatically, either in part or in full. Additionally, a user may edit any part of the schedule, as needed, either before or during live airtime, all in real time.

Any sort of audio and video file format may be used with the system, such as .wav, .mp3, .wma, .cda, .ogg, .mpeg or jpeg, for example. The system may run on any standard or specialized personal computer and may be designed for any existing operating system, such as Windows NT, 2000 and XP.

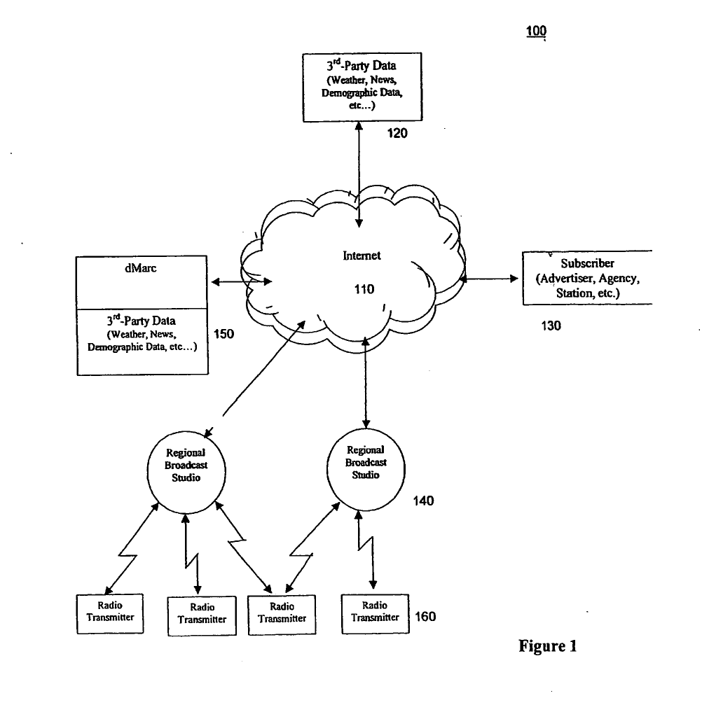

Referring now to FIG. 1, there is shown an architecture of a communication system 100 according to an aspect of the present invention. System 100 may include a networked environment 110 communicatively coupling party data 120, subscriber 130, at least one regional broadcast studio 140, and a broadcasting hub 150. At least one regional studio 140 may be further communicatively coupled to at least one radio transmitter 160.

Communication system 100 may include a broadcasting hub 150 configured with the broadcasting platform software of the present invention to store and forward verification of broadcast information of radio advertising and radio programming from at least one regional broadcast studio 140. This verified information may be forwarded to a data recorder for recordation of a sample of the information. Further, the recorded verified information may be parsed into campaign information and remainder of the broadcast information, wherein the campaign information may include radio advertising or radio programming information associated with a broadcast event. The data recorder may make accessible the verified information to networked environment 110 such that a myriad of verified information may be accumulated as necessary. Networked environment 110 may forward the verified information to a subscriber 130 and/or broadcasting hub 150 responsive to a request for the verified information.

According to an aspect of the present invention, the identification of when a radio advertisement or radio program was broadcast may be achieved. This identification may be performed utilizing the broadcasting software within broadcasting hub 150. Within hub 150 a data collector may identify verification of broadcast information related to an audio file associated with an advertising campaign or radio program, and may forward that information to networked environment 110. Hub 150 may include software for tabulating and formatting the information into a serviceable report, such as in response to a request by subscriber 130. The information in, for example, such a report, may be presented based on many different criteria, such as, for example, the total number of advertising or programming broadcasts per campaign, a listing of which stations the radio advertisement or program was broadcast over, an hourly breakdown of the broadcasts, the demographics of the broadcast audience, the geography of the broadcast audience, and/or the format of the radio stations, for example.

According to an aspect of the present invention, the reports available to subscriber 130 may reflect the latest information available. The verification of broadcast information may be forwarded from the data collector to networked environment 110, such as when the verification of broadcast information becomes available from broadcast hub 150. Such a substantially real-time report may provide subscriber 130 with substantially real-time data regarding the delivery of radio advertisements and radio programs.

According to an aspect of the present invention, the verification of broadcast information associated with advertising campaigns or programs may be combined with other information, and may be stored in additional databases either resident on or accessible by networked environment 110, to produce reports of demographic information about the audience of the advertising campaign or program. Such other information for combination with the verification information may be obtained, for example, from relevant internet or intranet sites, either automatically in response to an instruction included with the submission of the program to be broadcast, or manually upon receipt of a subscriber request.

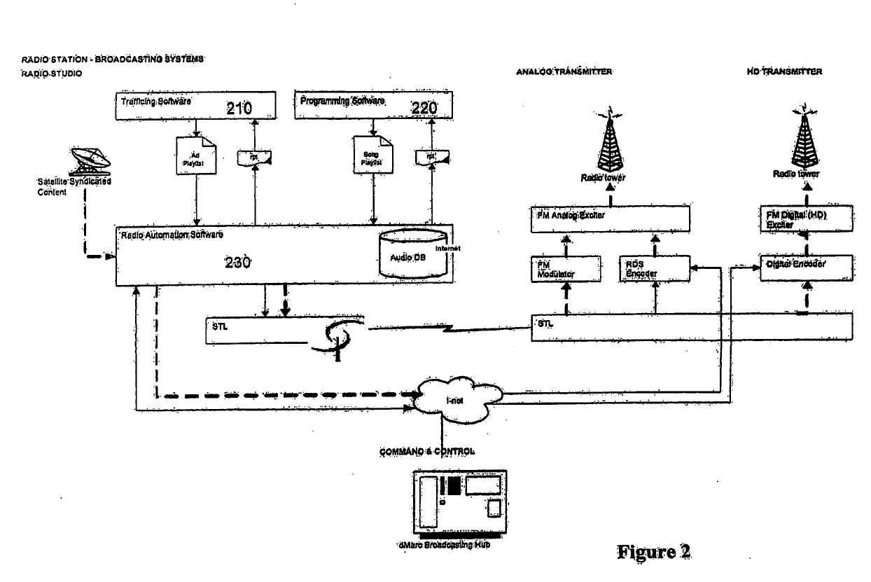

In order to more fully describe this interconnectivity, an exemplary embodiment is set forth herein below. Referring now also to FIG. 2, there is shown a system utilizing the broadcasting software platform according to an aspect of the present invention. Subscriber 130 may conduct one or more broadcast or advertising campaigns by purchasing radio advertisements across several local and regional radio stations. Subscriber 130 may distribute audio commercials to the radio stations for scheduling by a regional broadcast studio 140. Subscriber 130 may verify the delivery and track the broadcast of each of the one or more advertising campaigns and associated audio commercials. It may be beneficial for subscriber 130 to engineer the one or more advertising campaigns with a unique and corresponding file name. In this regard, each audio commercial digital file may have a subscriber 130—associated, unique file name. The audio commercial digital files associated with the advertising campaigns are referred to in this discussion as “campaign creatives.”

Regional broadcast studio 140, also having installed therein the broadcasting software platform of the present invention, may broadcast a campaign creative for subscriber 130. Regional broadcast studio 140 may initiate a broadcast of the campaign creative by scheduling broadcast delivery within its trafficking system 210 or programming system 220. The campaign creative may be loaded onto radio automation software 230 of station 140. The broadcasting software platform, denoted as radio automation software 230, may include the scheduling and/or “flight” information as provided by trafficking system 210 and programming system 220. In alternative embodiments, radio animation software 230 may include trafficking system 210 and programming system 220, such that radio animation software 230 may include the functionality of all three systems in a single platform. Broadcast hub 150 may forward scheduling information regarding the campaign creative, captured from radio automation software 230, to data collector. At the scheduled time, radio automation software 230 may stream the campaign creative to a station transmitter 160 for subsequent broadcast over the air. Broadcast hub 150 may forward verification of broadcast information regarding the campaign creative, captured from radio automation software 230, to data collector. The data collector may accumulate and/or store the information passed from broadcast hub 150.

According to an aspect of the present invention, data collector may isolate the verification of broadcast information related to campaign identifiers, for example, by including a table identifying the campaign identifiers. When verification of broadcast information arrives regarding one of the campaign identifiers in the campaign identifier table, the data collector may forward that verification of broadcast information (“campaign information”) to hub 150. The data collector may forward the campaign information as it arrives, or on a timed basis, such as in fifteen minute increments, one-hour increments, several-hour increments, or other increment known to those skilled in the pertinent arts. The rate at which the campaign information is passed from the data collector to hub 150 may limit how current, or real-time, a report may be. In this regard, the data collector according to an aspect of the present invention may be configured to provide the campaign information to hub 150 in real-time, such as not later than a few hours after the campaign information becomes available at the data collector. A portion of hub 150 may include a web server that receives the verification of broadcast information associated with each campaign identifier (the campaign information) from the data collector and stores that information on a permanent storage medium, such as a hard disk drive. The web server may tabulate the campaign information based on each campaign identifier. The table containing the campaign information may be as current as the rate at which the data collector provides the campaign information to the web server. Consequently, hub 150 via the web server may be able to generate reports of the broadcast of radio advertisements and radio programming in substantially real-time.

Hub 150 may provide access to the tabulated data over internet 110. Although internet 110 may be described as a wide area network for making the reports available to subscribers, those skilled in the art will appreciate that the system and method of the present invention encompasses any wide area network that allows access by subscribers to data stored on hub 150. Subscriber 130 may access hub 150 via a connection to internet 110. The connection to internet 110 may be any conventional connection that allows access to hub 150. For example, subscriber 130 may access hub 150 using TCP/IP and a conventional dial-up connection over a modem, or a dedicated connection that provides constant access. Hub 150 may have a unique HyperText Transfer Protocol (HTTP) address, a unique FTP address, or any other addressing scheme that allows subscriber 130 to identify hub 150.

Hub 150 may include server software, such as within a web server, that may allow subscriber 130 to request a report of a particular radio advertisement broadcast or radio program broadcast at any time. For example, subscriber 130 may connect to internet 110 in the middle of the day on a Tuesday. At that time, subscriber 130 may log on to hub 150 using a secure access protocol and issue a request to the web server to provide a report. The issued request identifies the particular radio advertisement or radio program of interest by campaign identifier. Hub 150 may respond to the request by reading the data stored in the table of campaign information associated with the campaign identifier provided by subscriber 130. Software resident on the web server may tabulate the report in accordance with the request. Finally, the web server publishes, such as in HTML or XML format, for example, the report to subscriber 130. In this manner, subscriber 130 may access and query the web server as frequently as desired to determine the broadcast of a particular advertising campaign or radio program.

Hub 150 and the web server may be configured to transmit reports to subscriber 130 at predetermined intervals, such as immediately, hourly, daily, weekly, or other time frame. For instance, software may be configured to simulate a subscriber request and cause the web server to generate and transmit the report to subscriber 130. Alternative means of delivery may also be employed, such as via electronic mail. These and other alternatives will become apparent to those skilled in the art upon a study of the disclosed embodiments.

Hub 150 and the web server may be configured to generate the report in response to a triggering event. Examples of such a triggering event may be a confirmation of broadcast for a select advertisement or program, or of a situation wherein an advertisement or program was scheduled to broadcast, but failed to deliver, or of an advertising campaign reaching a dollar cap value, for example. For instance, the web server may be configured to analyze the campaign information as it is received from the data collector. If the campaign information reflects that an advertisement with a specified campaign identifier was scheduled to broadcast at a certain time, but failed to broadcast, the web server may respond by issuing a flag to subscriber 130. According to an aspect of the present invention, the web server may be configured to extract from the campaign information the advertising client's telephone number, email, fax, or the like associated with the campaign identifier and transmit the broadcast information directly to subscriber 130 or someone associated with the subscriber, such as to follow up on the failed broadcast. The campaign information may be transmitted by digital or voice pager, by e-mail message, by human interaction, or by any other mechanism for alerting subscriber 130. In that manner, subscriber 130 may be substantially immediately notified that an advertisement failed to broadcast, and be provided with the radio station's contact information and advertising client information. Those skilled in the art will see the enormous benefits created by this aspect of the invention over existing technologies.

As may be evident to those possessing an ordinary skill in the pertinent arts, a myriad of reports may be created. By way of non-limiting example only, such reports may include campaign delivery by station, campaign delivery by market, campaign delivery by date, campaign delivery by hour, broadcast failure, and demographic reports. A campaign delivery by station report may identify upon which station a selected radio advertisement or radio program was broadcast. This report may enable subscriber 130 to verify delivery across a certain station, or within an associated geographic region. A campaign delivery by market report may identify the geographic market across which the campaign was broadcast. This report may enable subscriber 130 to verify delivery and coverage within a certain market. A campaign delivery by date report may provide subscriber 130 with per-day totals of broadcasts associated with a specified campaign. Subscriber 130 may use this type of report to easily identify those days with the heaviest advertising and programming response, such as for support planning purposes. A campaign delivery by hour report may provide subscriber 130 with per-hour totals of broadcasts associated with a specified campaign. Subscriber 130 may use this type of report to identify those day parts with the heaviest advertising and programming response for support planning purposes. A broadcast failure report may provide subscriber 130 with a listing of the campaigns that were scheduled but failed to broadcast. This information allows subscriber 130 to attempt to manage sales support, and take action to remedy failure. A demographic report may be provided. For example, the advertising campaign, broadcast across a specific market, may be mapped to area code or zip code to provide subscriber 130 with a broad overview of geographic locations of the receiving broadcast audience. Additional databases, such as those available from Census information, may be employed to generate financial, ethnic, and age-related demographic information which may be of use to subscriber 130.

Stations may desire and may be able to isolate themselves from the internet for a myriad of reasons. According to an aspect of the present invention and pursuant to what is currently deemed best practice for radio stations, stations may isolate mission critical on-air work stations from the public internet. Specifically, the present system may enable on-air workstations to connect securely to a data center over the internet without the on-air workstation being connected directly to the internet. Such a configuration may be achieved and optimized by using encryption and secure protocols, including, but not limited to outbound-only protocols.

Any networking model may be used such as a local proxy or local connection for example. Connecting using a local proxy need not require internet connectivity, and instead may require only connection to a local area network (LAN). One computer on the LAN may have two network cards, one of which communicates with the local proxy which in turn communicates with the data center via an encrypted outbound only connection. On the other hand a direct connection may require on-air workstations to have internet connectivity and may provide an outbound only connection to the data center.

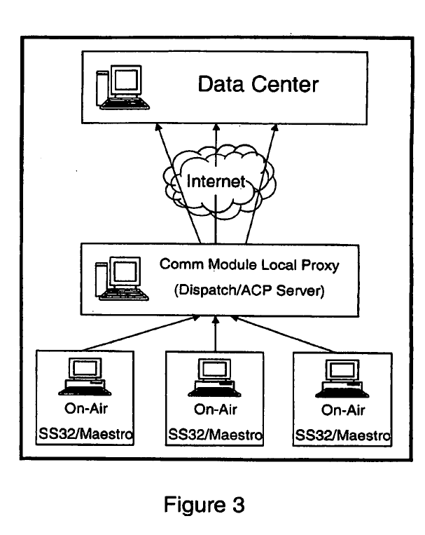

As may be seen in FIG. 3, a local proxy may provide an encrypted connection to the data center and a reduction in the overall network traffic. Local proxy may use the broadcasting software platform, denoted here as “SS32/Maestro” along with the local proxy to create an encrypted and secure connection to the data center. For this to happen, the broadcasting software platform may be present on each of the on-air automation workstations along with a local proxy module within the network. To establish the encrypted connection with the data center, the modules may rely on the station to have a dedicated internal automation system LAN and a separate corporate LAN with internet connectivity. There may also be one machine that is multi-homed, meaning it has two network cards and is aware of both networks. In most installations, the multi-homed machine is usually the dispatch or a server. With both modules and hardware/network configuration in place, the broadcasting software platform may automatically attempt to connect to the local proxy. Local proxy may, in turn, attempt to establish an encrypted connection with the data center. Local proxy may be designed to make use of the default network settings of the multi-homed machine for both the automation system LAN and the corporate LAN. Therefore, these network settings may remain largely unchanged. Additionally, the local proxy need not rely on Host name to connect to the data center but rather uses an IP address, therefore no DNS configuration should be necessary. Local proxy network settings may be modified if any of the default settings have been changed to block outbound internet traffic from the multi-homed machine over the corporate LAN or if inbound traffic from the automation system LAN has been blocked to the multi-homed computer. If these defaults have been modified, additional changes may be needed, such as: the multi-homed computer connecting outbound to the internet over the corporate LAN, such as on port 443 (HTTPS), for example; the multi-homed computer connecting outbound to the internet over the corporate LAN, such as on port 10,000, for example; the multi-homed computer connecting outbound to the internet over the corporate LAN, such as on port 80, for example; on-air workstations connecting outbound over the internal automation system LAN to the multi-homed computer, such as on port 10,000, for example; multi-homed computer accepting inbound traffic from the internal automation system LAN, such as on port 10,000, for example. Under such a configuration local proxy module may use specific ports to direct encrypted outbound-only traffic over the internet. For example, ports 443 (HTTPS) and 10,000 may be used for transmitting encrypted station information and module control traffic. Selection between these ports may be optimized to preserve system resources. Port 80 may be used for downloading unencrypted media files from the data center. After configuring a station's network, the on-air automation workstations may connect to the data center through the local proxy module automatically.

The system may further incorporate specialized networking routers, which may provide hands-free, automatic transfers for sharing logs and audio files amongst multiple stations with one touch. Such a router may be, for example, a multi-protocol router that sends files over high-speed Internet connections and uses one FTP site for all stations. This system may allow a user to set schedules for automatic file transfer, or transfer files, playsets or logs on demand, among interconnected stations or even an off-site backup server.

It should be understood that the broadcasting system of the present invention may be used not only for any standard or traditional radio broadcast, but also for internet or network based broadcast, and for any type and combination of audio, video or other multimedia play.

It should also be understood that the present invention may allow a user to access and/or monitor multiple radio stations and/or production studios remotely, provided such stations and/or studios are connected within a network, such as a Wide Area Network (“WAN”) or a Local Area Network (“LAN”). For example, and referring back to FIG. 1 generally, multiple radio stations positioned across the United States may be connected via the internet to a single hub. From the hub, a manager may oversee and edit playlists and other scheduled clips in any of the radio stations as needed. In another example, multiple studios located within a single building may be connected via a LAN to a central hub, where, as mentioned previously, a manager may oversee and make edits to files in any of the studios as needed.

According to another aspect of the present invention, where a central hub may function as a control center, and may monitor the system running on several remotely located radio stations or studios, the system may incorporate alerting features for the hub regarding the status of any particular radio station connected thereto. For example, when a monitored system at a particular station is operating normally, its display may be green. If a monitored system reports to the hub that future problems are possible, that display may turn yellow and/or have an alarm sound. In such a situation, the hub may call or email the appropriate personnel. If a problem actually occurs, the display may turn red, and the warning actions may be incrementally escalated.

In yet another example network utilizing a central managing hub, alerts or weather bulletins may be sent by the hub to any of the interconnected stations automatically and/or manually. The broadcasting software platform located at the hub may optionally zoom in on any particular station for full control of the station's software platform as if you were at that station. Thus, any station may operate locally, or from the hub, or share joint control between the two locations at any time.

An authorization and priority system may also be implemented, requiring identifications and passwords for overriding or bypassing control of or from any particular location over another. When implementing such a security system, station management may permit or prohibit users from making substitutions of files or logs on a shift-by-shift basis.

According to another aspect of the present invention, functional features of the broadcasting software platform may be configured uniquely to a user, such that each user may configure their screens to their preferences, and such preferences may display automatically during their shift at the station or hub.

According to another aspect of the present invention, the broadcasting software platform provides an efficient and easy to use graphical user interface that may allow a user to add, drop and edit files merely seconds before live airtime. For example, the system software may provide selectable icons, such as “play” buttons, to initiate play of any file when selected. These icons may be selectable by a mouse point or active cursor, or may incorporate a “touch screen” for active selection. Voice activated selection, or any other method of icon selection as understood by those skilled in the art, may also be used. The system may also incorporate a drag-n-drop interface, with keyboard shortcuts available to a user. Any number of selectable icons may be used. For example, twenty, fifty or one hundred icons representing individual files may be located on a single screen, or, multi-layer screens, using a tabbed or hyperlinked format, may be used to increase the number of selectable icons. In one embodiment of the present invention, thirty sets of “play” buttons may have up to thirty keys, which may rotate up to one hundred files.

The present invention may further include an organized and user-friendly visual interface which may display all or any portion of a library of audio files entered into the system. For example, the interface may show when a file last played, and provide a visual verification of airtime, where logs of any scheduled individual files or file groupings may be viewed. These logs may also be accessed and edited by a user as needed. Further, controls for adjusting any audio file or log may be located on-screen, allowing a user to select and edit such files or logs. An insert window may display an entire library of digital files, or any portion of a digital file library, much like a “cart wall”, which may additionally show when a file last played.

The present invention may further incorporate a searching engine, for searching various characteristics or features of files. These characteristics may be preexisting, or may be added to a file, such that a particular user may search based on their own desired searching characteristics or parameters. For example, a user may search for songs by title, artist, music category or length of file, or any other parameter suitable for conducting a search.

According to another aspect of the present invention, files may be scheduled in groups or sets, and the group or set may be selected as one scheduled unit. Groups may be expanded or collapsed as necessary to show a single line or multiple lines in the play list. Such scheduling may allow a user to preset packages which flow in groups more smoothly than continuous individual selections. The play list may show a graphical view of the flow of songs and other sound files. Time information about the next cue point or control event in the play list may also be provided. Additionally, multiple playlists may be constructed, such that while one playlist is playing on live air-time, other playlists, groups or sets may be constructed ordered for sequential play. Playlists may further be scheduled for play by specific parameters, such as, for example, by starting a playlist at a specific time. The broadcasting platform may also allow for random play and/or selection of files based on specific parameters, such as Title, Artist, Filename, Album, Genre, Tempo, or parameters based on buzz words such as “promo,” “sweeper,” “jingle” or any other word a user may choose to associate with particular files.

According to yet another aspect of the present invention, a recording mechanism may be incorporated into the software platform, such that a user may select a particular file and record over any portion of it. For example, blank spaces may be trimmed from the front and/or back of a song file, and songs may be normalized for maximum volume on peaks. Such editing may be made to fine-tune the timing and levels of the file for better control over file transitions. Additionally, tags or markers may be encoded into a file, or, inputs based on previous play of a file may provide for recognition by the system software for running other features, such as a countdown clock from the start time to the beginning of the lyrics of a song, or a countdown until the end of the file.

According to another aspect of the present invention, the broadcasting software system may include a phone editing function that may record calls on separate tracks, which may further be locked or separated for editing. Such a phone editing function may be used and viewed in half-screen or dual-screen modes, or in separate windows.

According to yet another aspect of the present invention, “intros”, “outros” or “hooks” may be recorded onto files before they air, or, for example, an outro may be previewed while a song file plays. Additionally, the hooks, intros, and outros of files may be defined as they are recorded, which may allow for their use to build promos without re-recording.

According to another aspect of the present invention, a user may mix an external signal, such as a radio signal, into a playlist. For example, a station may create or provide the music, commercials for a playlist, but not make or provide the news. In this situation, the news feeds may be taken from the air and mixed into the playlist.

According to another aspect of the present invention, a voice tracking function may be included in the broadcasting software system. For example, a user may hear beginnings or endings of songs and spots in a headphone set while recording. The user may then select his or her name from a pick list. From then on, a touch of the spacebar may allow movement to the next logical function. If any song or spot is moved or dropped after a show is voice tracked, the software system will not play an incorrect voice track. Instead, the system may substitute a generic track created by the user. Additionally, the voice tracking function may show a user song titles, artists, intro times, lengths, tempos, years, CD names, and trivia related to the particular file.

The present invention may also calculate commercial and talk time based on a final log and display a “real time” clock, or let the system insert a proper track from any number of pre-recorded applicable lines. In another example, an optional temperature announcing module may let the system select a proper voice tracked temperature recording based on a reading from an electronic outdoor thermostat.

The present invention may also scan new music logs for schedule voice tracks and may automatically compress the beginnings or endings of the songs next to the voice track. Such functions may also be accomplished manually by a user. For example, the system may provide a user with telescoped song beginnings and endings in the user's headphones so the user may hear it while recording. Finished voice tracks may then go over the Internet back to the station where they may be broadcast.

According to another aspect of the present invention, network programs and satellite feeds may be delayed as needed. For example, the system may capture satellite feeds automatically, and may start and stop recordings at specific times or when a command may be received from the network. The intuitive scheduling feature may allow a user to schedule the programs desired for capture, whether they may be single events or have multiple parts. In one exemplary embodiment, the system may record up to four feeds simultaneously and may control an audio switcher.

In the event of an emergency, a synced backup system may seamlessly take over broadcast systems, which may eliminate the concern of a station going off the air due to system failure. Further, satellite automation may also replace missing or outdated recordings on the fly. Additionally, a daily “output log” file showing everything that played, and the time at which each item played, may be provide and incorporated into a record keeping function, that may further be selectable by a user.

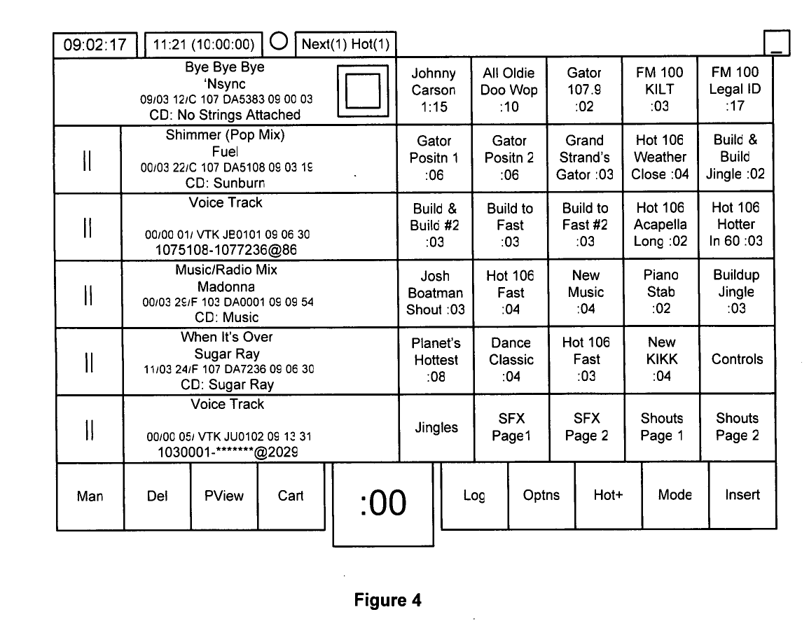

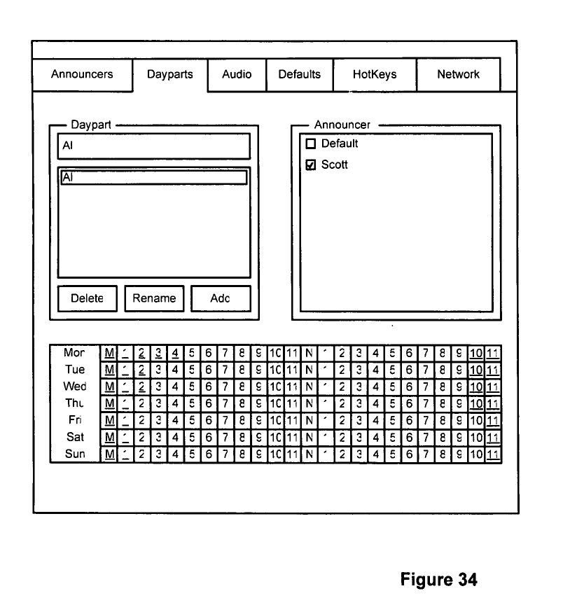

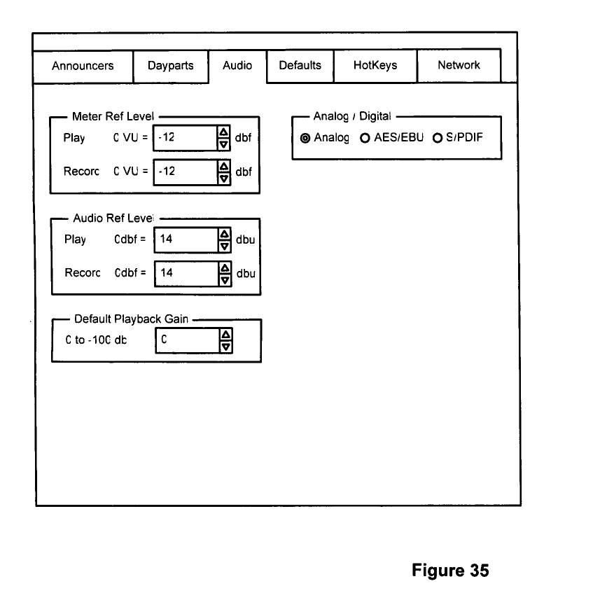

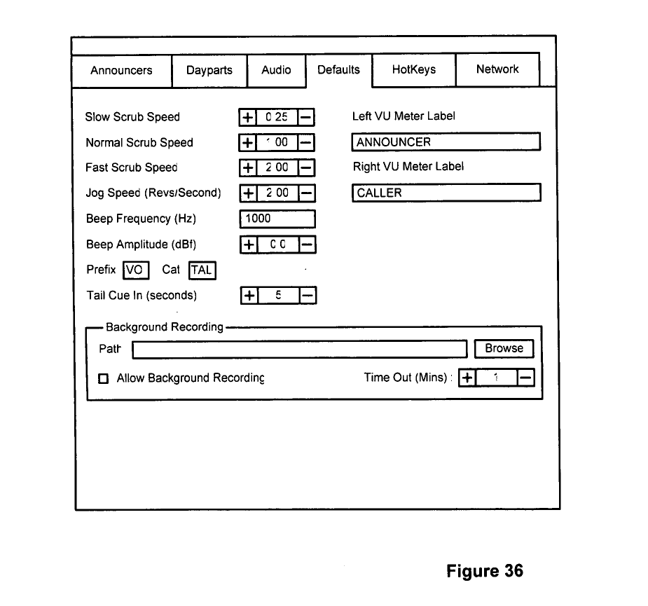

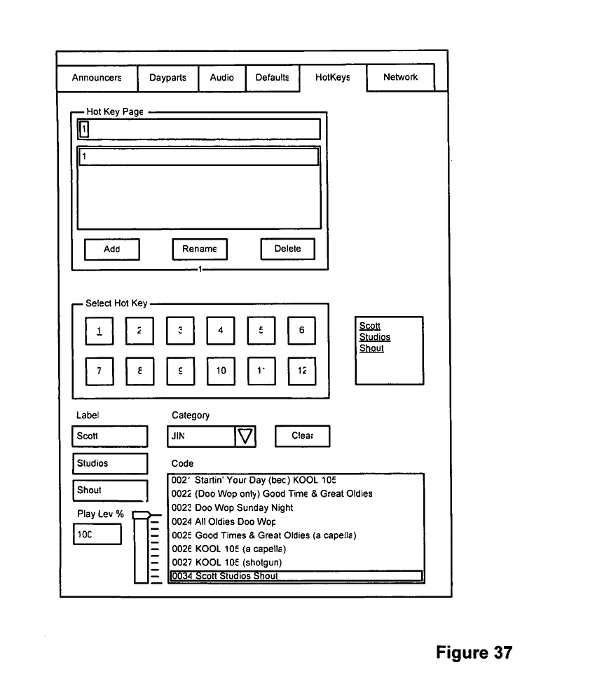

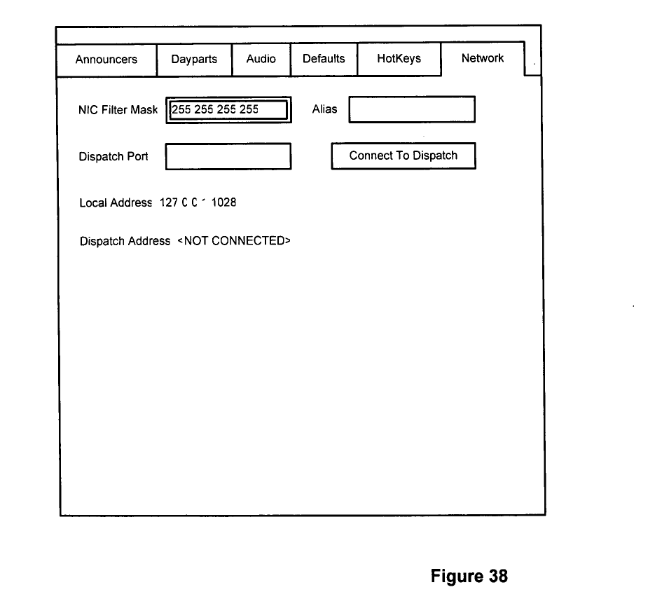

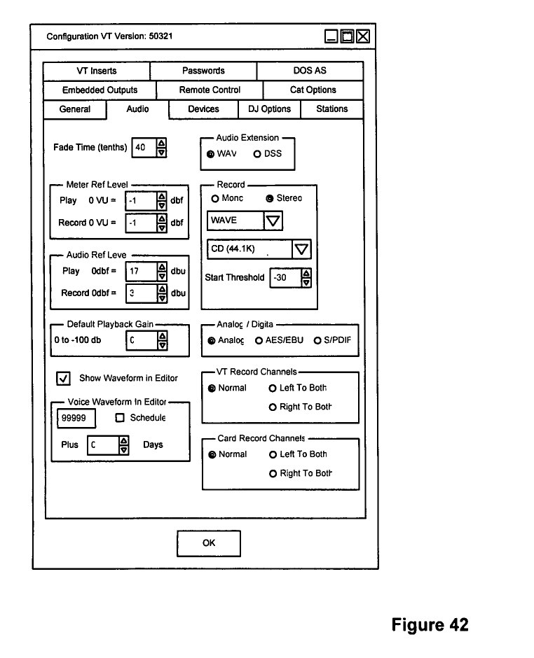

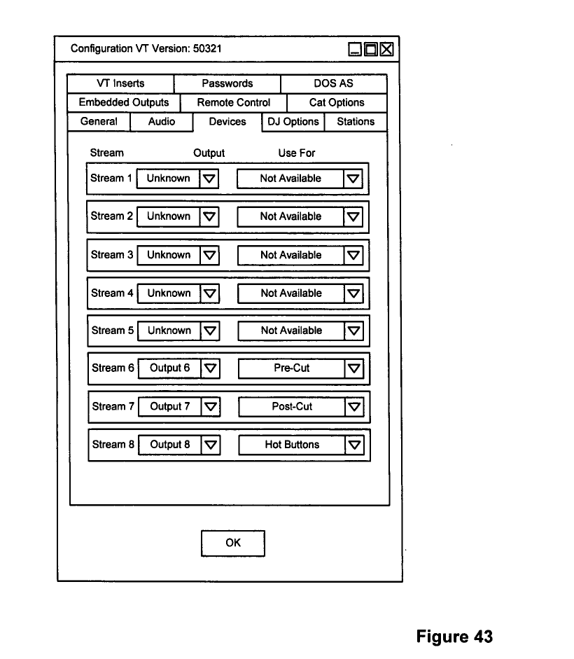

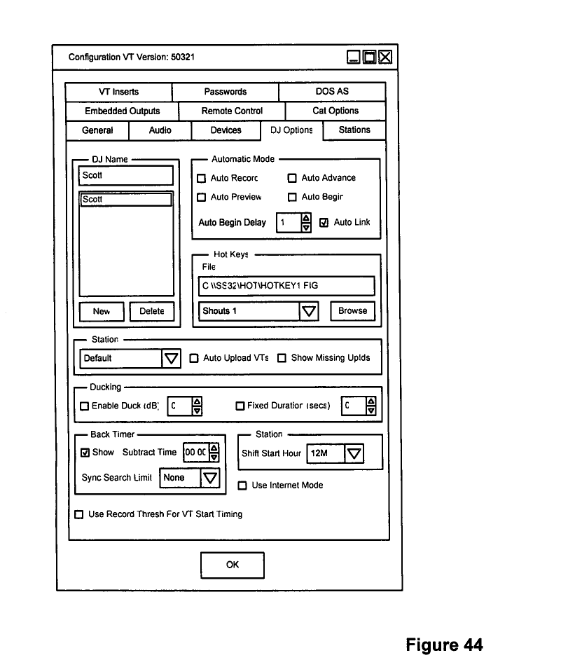

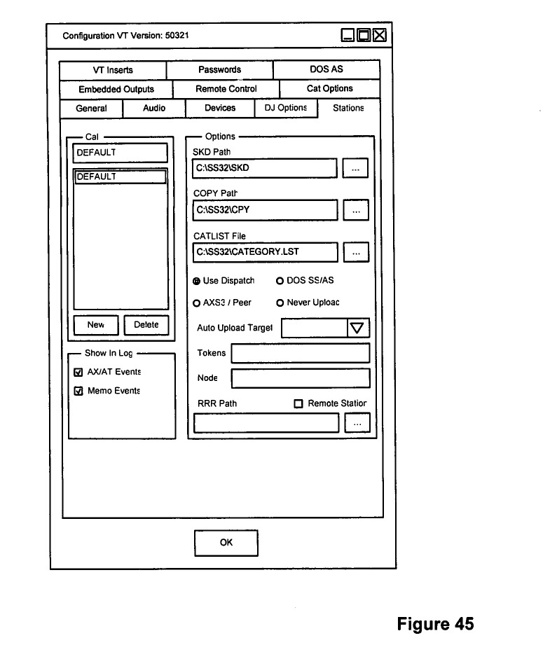

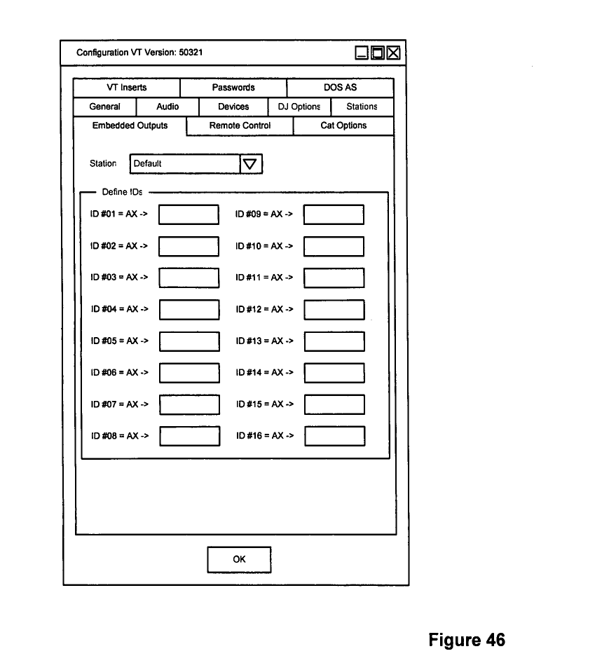

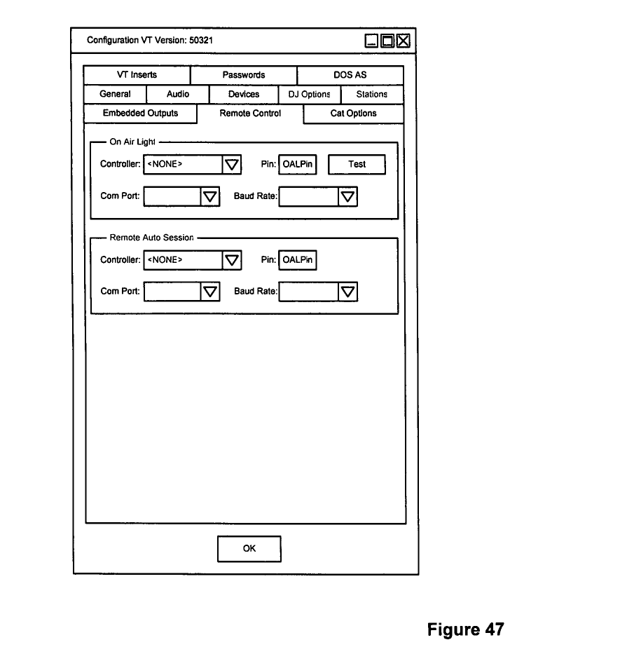

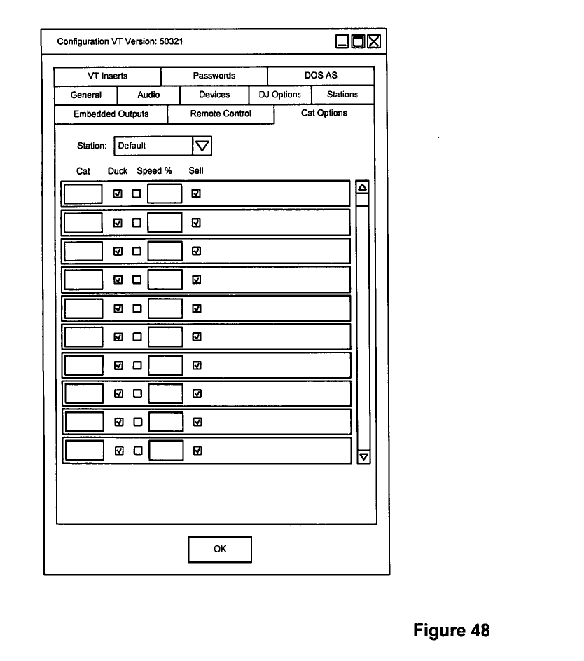

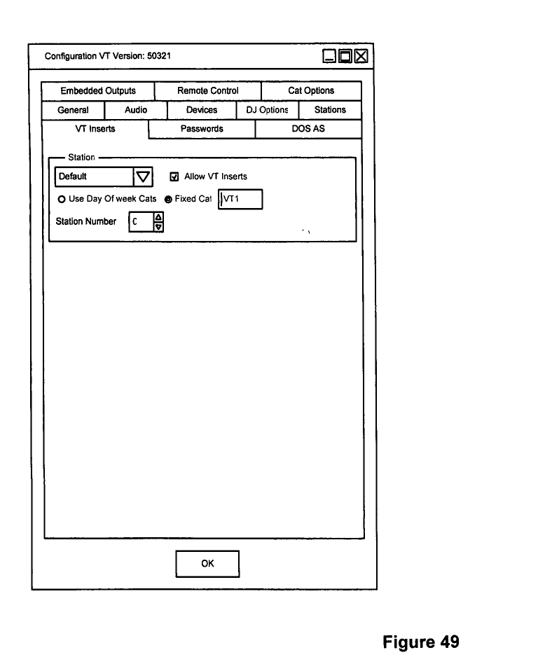

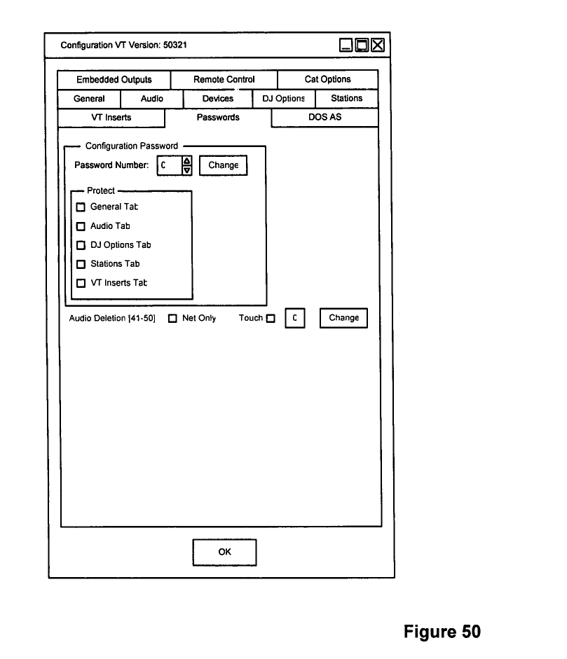

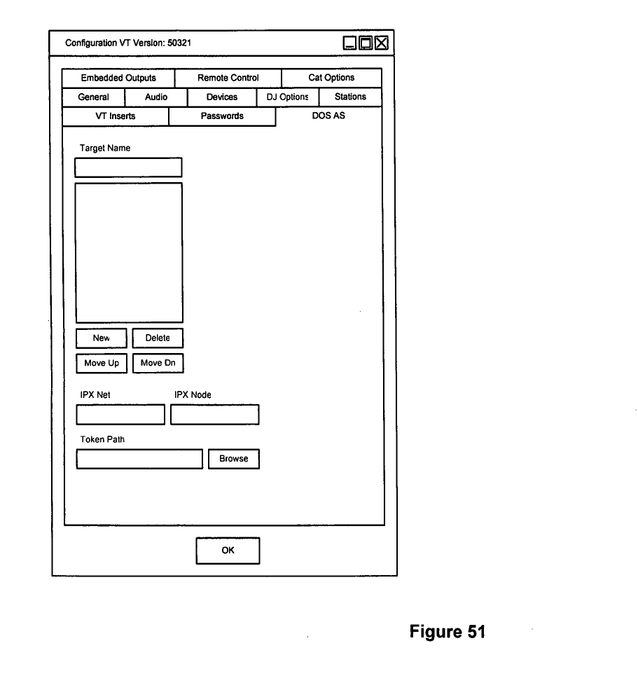

By way of non-limiting example only, a selection of exemplary screenshots illustrative of the broadcasting software platform have been provided as FIGS. 4-54. As illustrated in FIG. 4, the present invention may provide a play list 101, a staging area 102, a timer 103 as well as a variety of menu options. For example, the play list 101 may include a variety of media including songs, advertisement, information spots and/or other media. The play list 101 may be chronologically sequenced. For example, the voice track may be sequenced ahead of the music radio mix song by the artist Madonna, allowing the voice track to play before the music play.

The present invention may also include the ability to manually control the play of media, the ability to delete media from the play list, the option to preview media either in the play list or in the staging 102, and the ability to view media that may be available to the user of the present invention. As illustrated in FIG. 4, a cart button may be clicked to display available carts in the staging area 102. For example, the cart entitled “Gator 107.9” has a run time of two seconds, as illustrated on the cart access button, and may include a pre-recorded media identifying, for example, that the broadcaster is broadcasting as “Gator 107.9 FM”. Any cart stored by the present invention may include any type of pre-recorded media, as well known to those skilled in the art. As further illustrated by FIG. 4, a cart access button in the staging area may also provide access to additional carts or media holders categorized by subject. For example, a cart access button labeled “jingles” may allow the user of the system to access, in the staging area 102, for example, any carts stored in the system that may be associated with jingles and the like. By way of further non-limiting example, clicking the cart access button labeled “FSX Page 1” may allow the user to access carts that include sound effects. Additional features provided for the carts include access to the log, access to further options, locating carts that are hot plus, accessing the mode, or simply inserting carts into the play list.

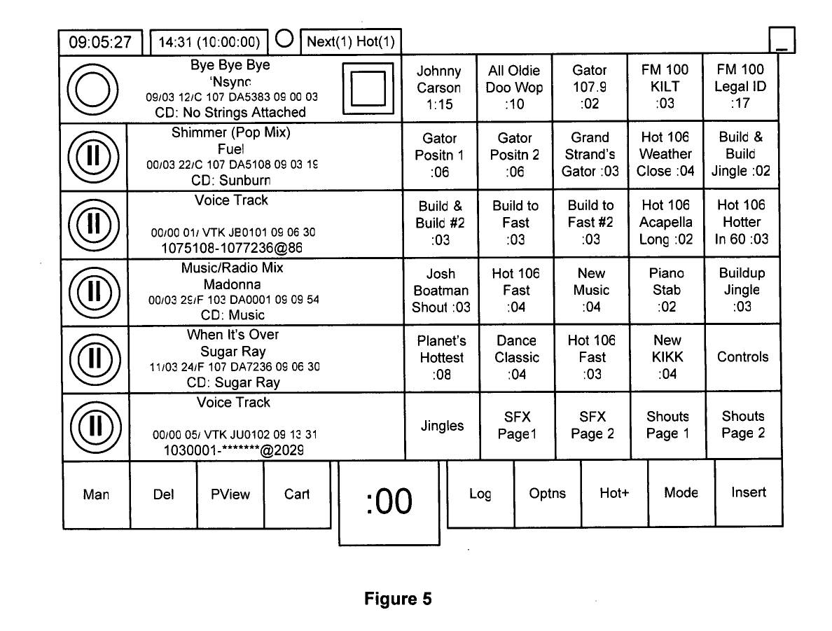

As illustrated in FIG. 5, when the user clicks on the time 103, a bull's eye is presented over the play pause button on media in the play list.

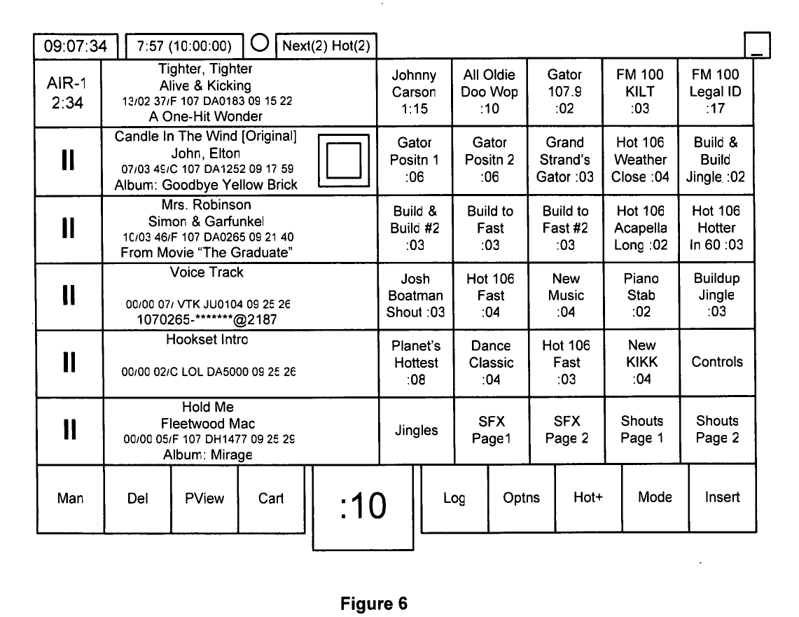

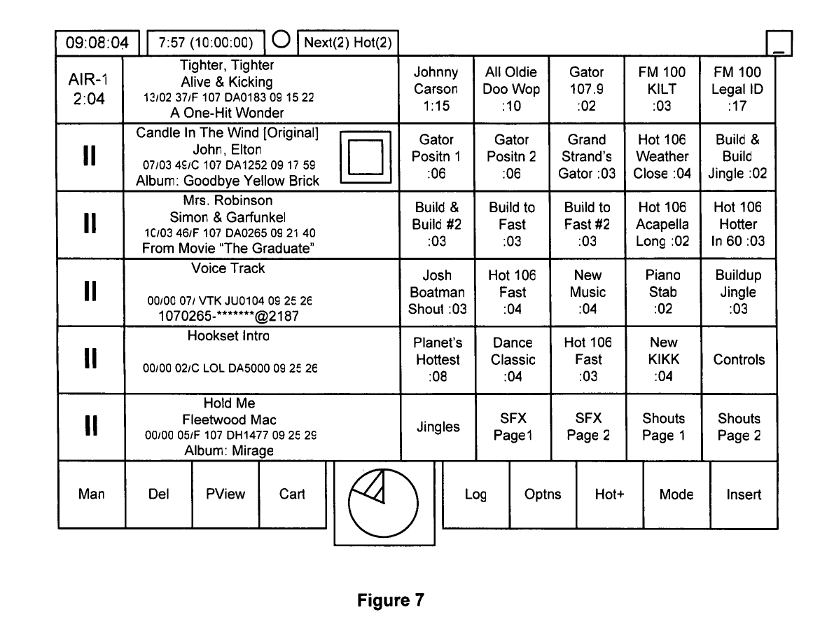

FIG. 6 illustrates an aspect of the present invention which may include the use of a timer to determine the amount of time between the start of a media play and the start of the desired content of the media play. The desired content of the media play may include, for example, the lyrics to a song or the words of an advertisement. The time 103 may provide a count down of the time between the start of the media play and the start of the desired content. The file representing the media play may include a programmed “tag” within the song or promo, such that the system may recognize a particular spot within the song to start and stop a count down. By way of non-limiting example only, as illustrated in FIG. 6, the song “Alive and Kicking” is shown to have a run time of 2 minutes 34 seconds. The timer 103 is indicating that there are 10 seconds between the start of the song and the start of the lyrics. This differential in time may allow the user of the present invention to insert other media over the media playing. By way of non-limiting example only, the user of the system may start playing the song “Alive and Kicking” and may talk over the song while the song is playing until the start the start of the lyrics. In the example illustrated by FIG. 6, the user of the system would have 10 seconds of available time until the lyrics of the song started. This may enable our user of the system to accurately identify the amount of time they have to interject over a media play before the desired media begins. Similarly, the timer may also take a graphic form as illustrated in FIG. 7. By way of non-limiting example only, the time may switch from numerical to graphic when a certain amount of time remains, more easily allowing the user of the system to appreciate or comprehend the amount of time remaining.

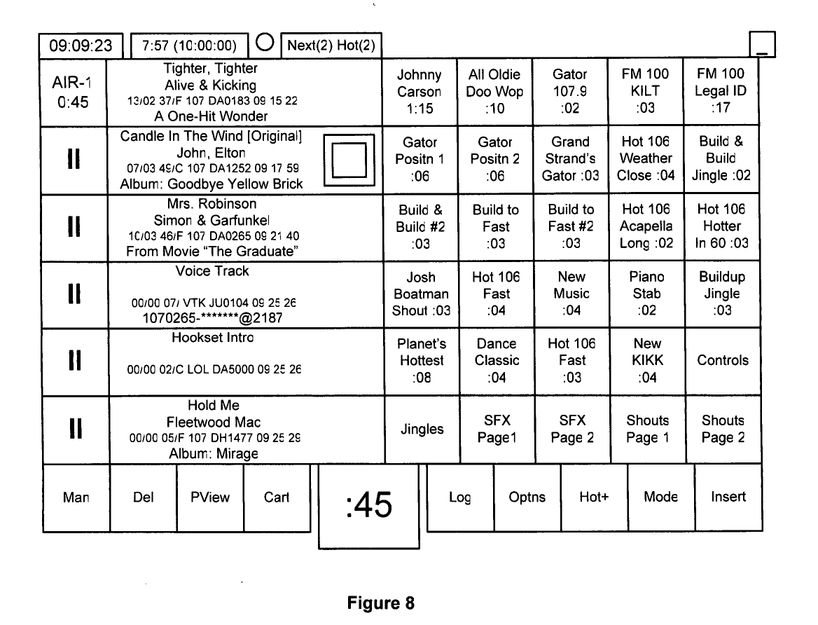

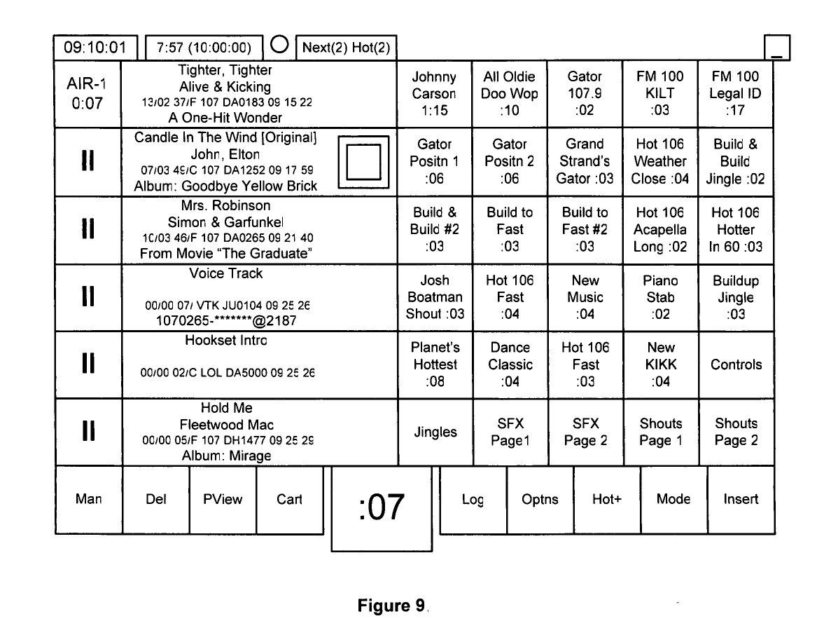

As illustrated in FIG. 8, the timer 103 may provide a count down alerting the user as to how much time remains for the current media play. For example, if the song “Alive and Kicking” has only 45 seconds remaining until it is finished, the timer will be counting down from about 45 seconds to about 0 seconds. This aspect of the present invention is further illustrated in FIG. 9. The timer may be colored, flash, or provide a sound to alert the user of the system that the media play is coming to an end.

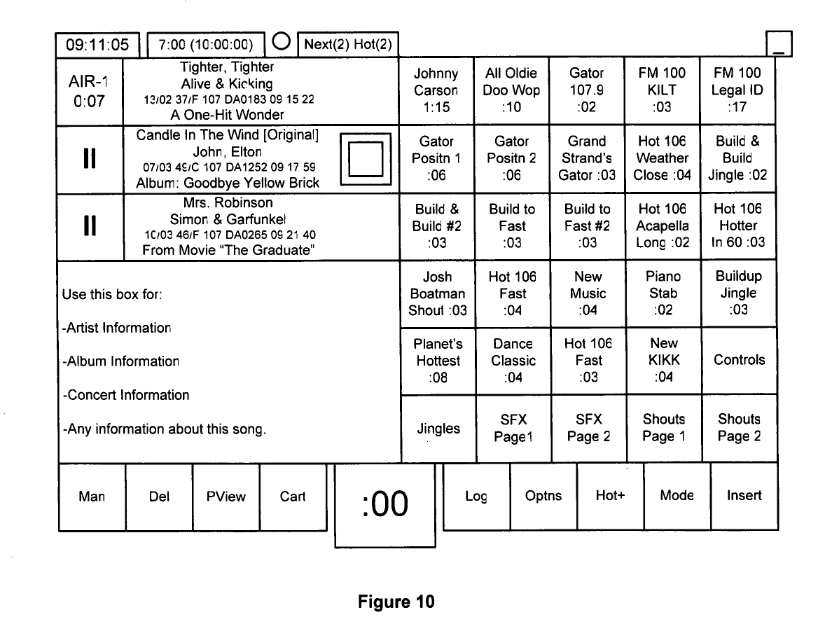

As illustrated in FIG. 10, particular information for media stored within the system may be displayed. By way of non-limiting example only, a song in the play list may be clicked to provide a window of information such as artist information, album information, concert information and any particular information about the media play itself. Such information windows may be provided by the artist, the originator of the media play, by a service providing the media play, and/or edited by the user of the system. The information may further be updated at any given interval and may also provide real time information about the media play.

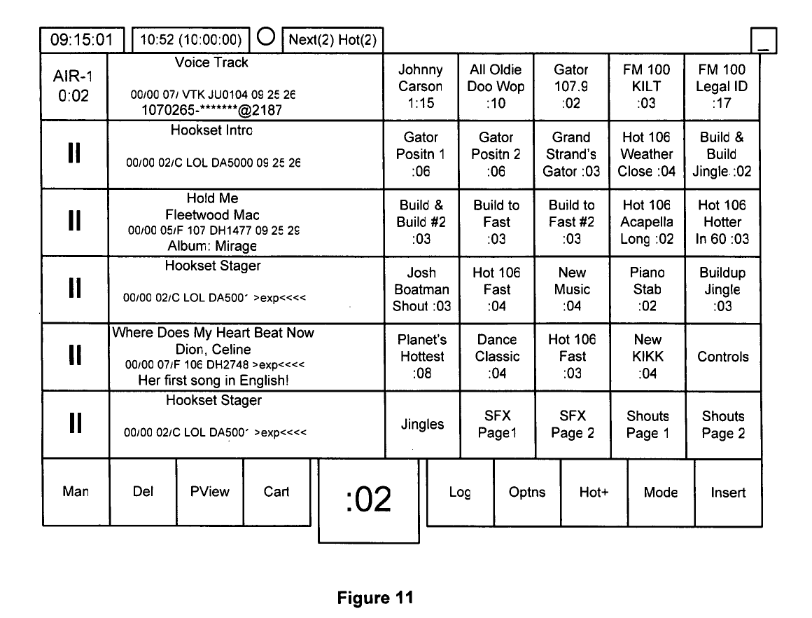

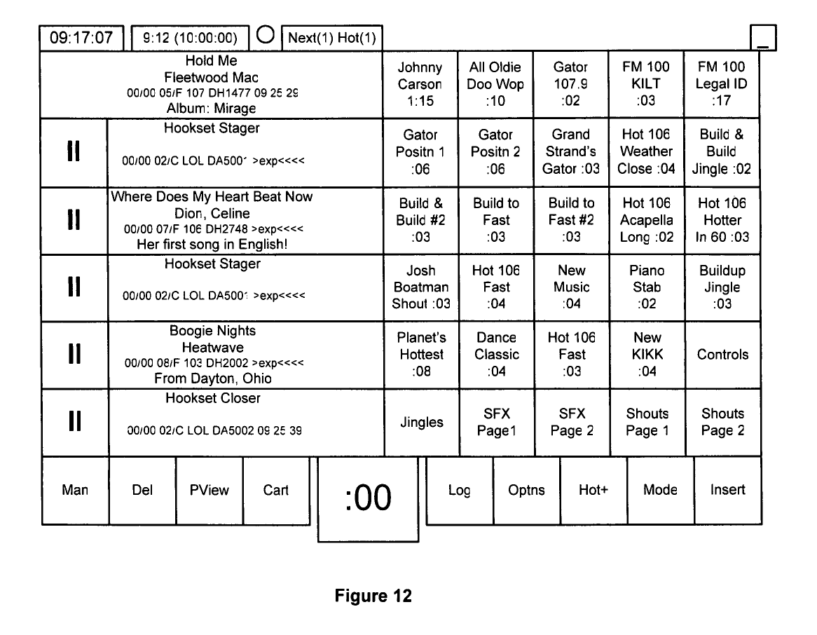

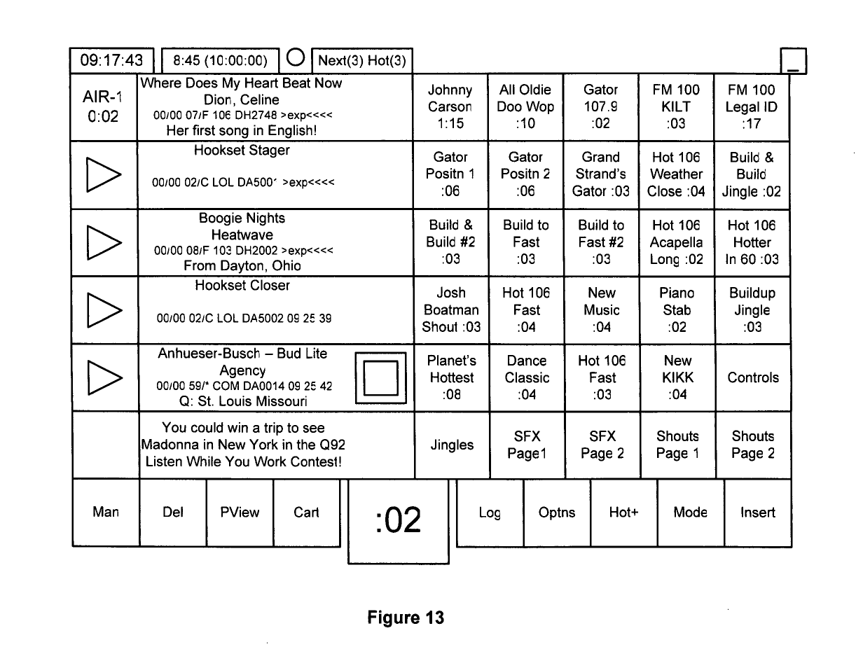

The present invention may provide for the full automation of media play as well as providing the ability for manual operation by the user. As illustrated in FIG. 11, by clicking the manual button, a user may choose to pause all media plays in the play list. By way of non-limiting example only, although the media entitled “voice track” is currently on air with two seconds remaining in the play, all following media plays in the play list are paused. As illustrated in FIG. 12, during manual operation of the present invention, the next media to play in the play list may not play unless manually started by the user of the system. By way of non-limiting example only, the song “Hold Me” by Fleetwood Mac, although at the top of the play list, will not play until started manually by the user. By clicking on the “pause” button within the play list, a user may either directly play the media next to “play”, or actively queue the media play within the play list. FIG. 13 illustrates the active playing and queuing of several media plays in the manual mode in the present system. As further illustrated in FIG. 13, when a first media play ends, the subsequent queued media play will start in either the manual or automatic mode of the present system.

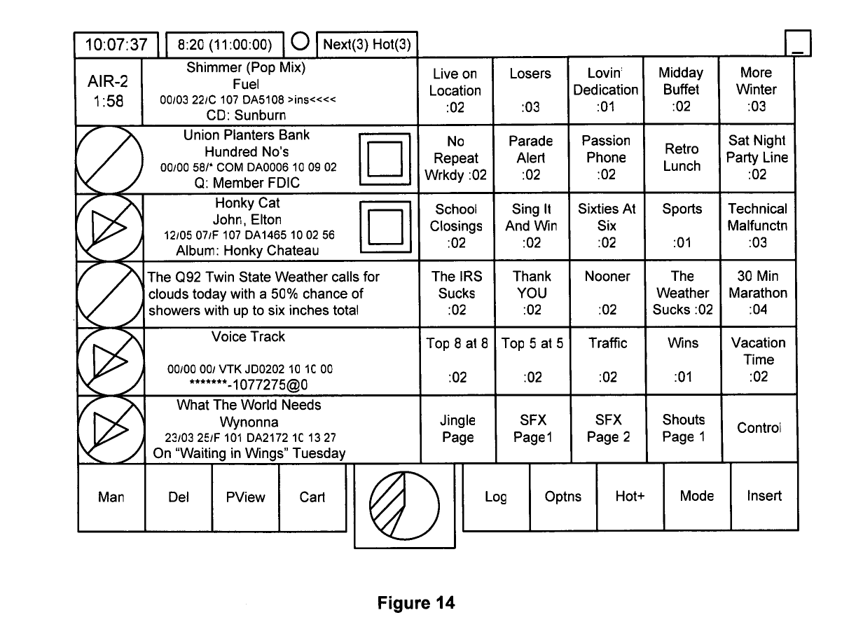

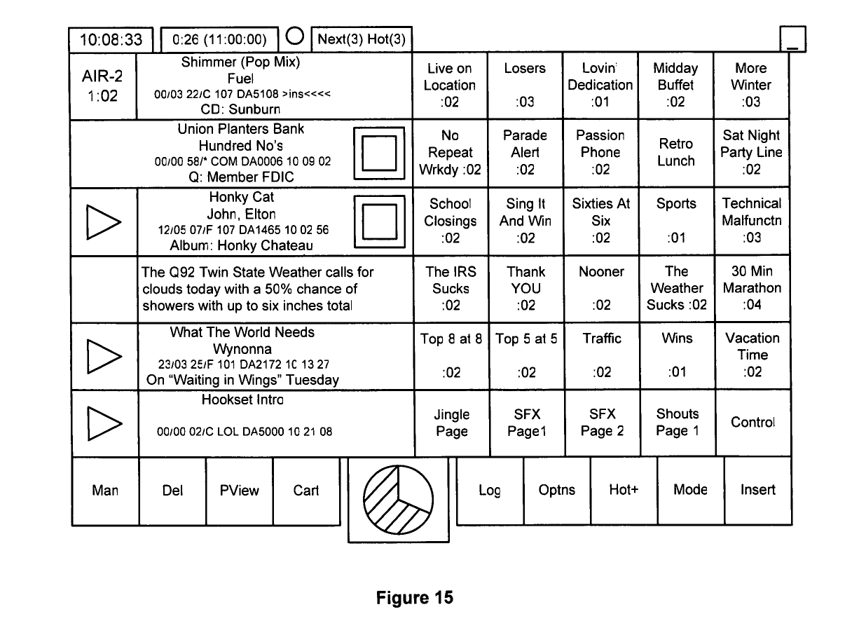

Media plays from the play list may also be deleted by the user by selecting the media play and hitting the “delete” key, for example. As illustrated in FIG. 14, if a user incorrectly tries to delete a media play, or if a media play cannot be deleted, a “no delete” sign may appear onto the media play. If a media play is successfully deleted from the play list, the subsequent plays may be forwarded in the play list. By way of non-limiting example only, if the user deletes the voice track media play from the play list as illustrated in FIG. 14, the song or media play by Wynona entitled “What the World Needs” will be forwarded in the play list as illustrated in FIG. 15.

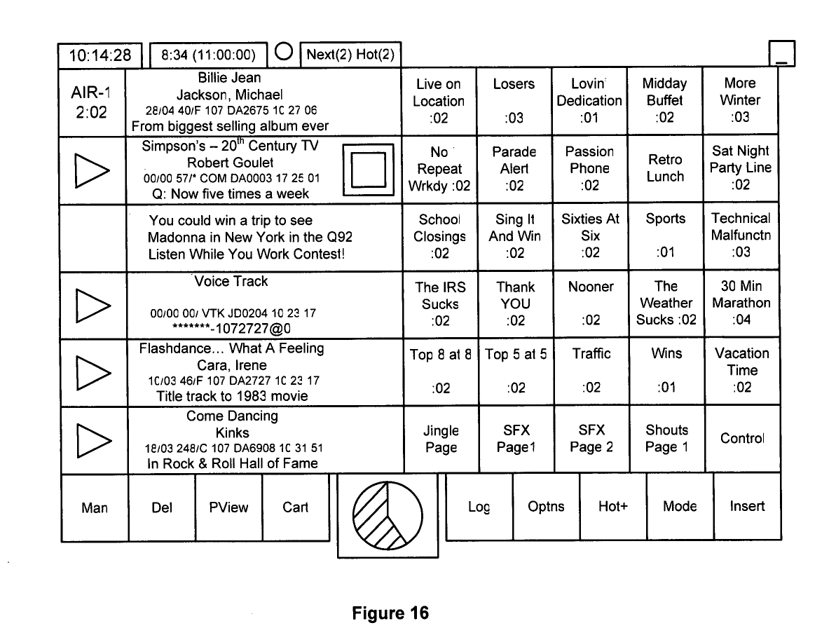

As further illustrated in FIG. 15, a media play may consist of a “hook set intro”. This type of media play may include voiceovers and/or media clips that may facilitate a transition between media plays in the play list. For example, the hook set intro may contain a description of upcoming media plays from the system, may provide audio clips of upcoming media plays and/or other information regarding past and future media play by the present system. By way of non-limiting example only, and as illustrated in FIG. 16, a hook set intro or voice track may be associated with one or more media plays within the play list. By way of non-limiting example only, the media play entitled “Flash Dance—What a Feeling” may have associated therewith a voice track that introduces the song so that when the song is imported into a play list, the associated voice track automatically perceive the song media play. Further, such voice tracks may or may not be associated with any particular media play depending on the content of the voice track and the association provided by the user and/or originator of the media play.

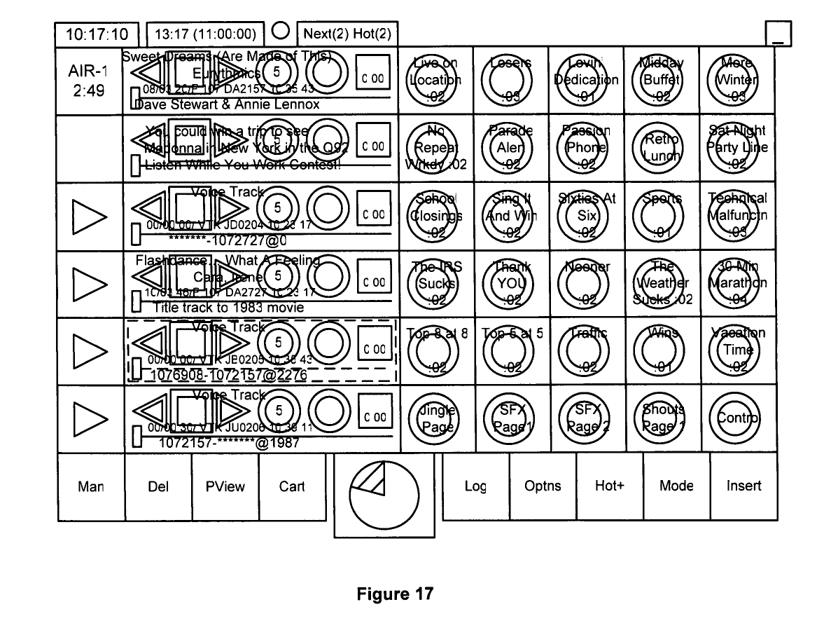

The present system may also allow for the previewing of media within the system. As illustrated in FIG. 17, the user of the system may click the “preview” button which may provide a display of play controls on media within the play list and cart list. These controls may allow user to play, pause, rewind and otherwise preview portions of media play. Such a review of the media play may not be broadcast by the system and may be limited to a user of the system.

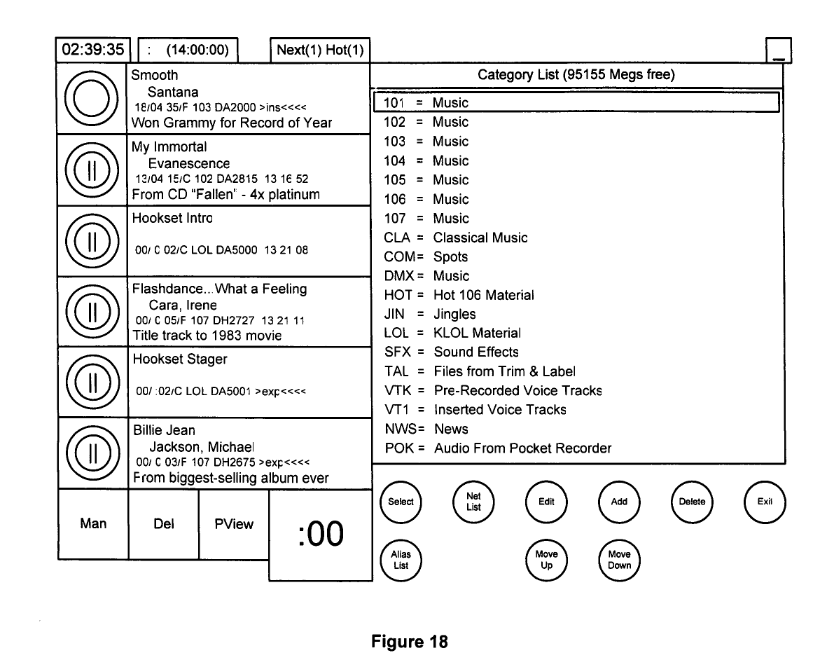

By clicking the “cart” button as illustrated in FIG. 17, the user may be presented with a list of carts contained within the system as illustrated by FIG. 18. Carts, as they are often referred to by the radio industry, may be discrete media plays covering a wide variety of media including, for example, song, jingles, sound effect, voice overs, news spots, advertisements, and Public Service Announcements (PSAs). As illustrated in FIG. 18, the present system may include a variety in carts and may list them numerically, or with abbreviations. By way of non-limiting example only, the system may include seven libraries of music numbered 101-107, a classical music library, identified by the abbreviation CLA, and a sound effects library, identified by the abbreviation FSX, for example. The present invention may allow the user to select a given cart library, view a world wide web list of available libraries, edit a library's description under content, add a library, delete a library, provide for an alias list of the libraries contained in the system or exit from the cart menu. By clicking the “select” button and/or double clicking on a listed cart library, the user may find or may be presented with a list of media within a given library.

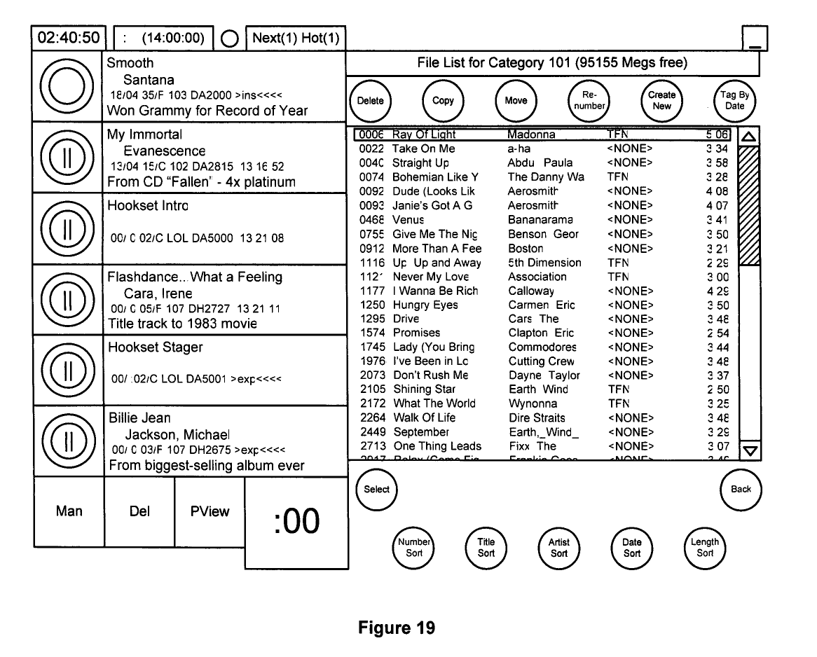

By selecting or double clicking library 101, the user may be presented with a list of music within the library as illustrated in FIG. 19. A listing of the cart library may include the numerical identification provided for each music play, the title of a media play, the artist or originator of the media play and the time or length of run of the media play, for example. The present system may allow the user to delete, copy or move a media play, renumber the media play, create a new media play or tag a particular media play by date. The creation of a new media play within a particular library may be further facilitated by any means allowing the user to introduce a media play to the system. This may include, for example, uploading a media play from the CD, a cart or the web. The system may further allow the user to sort the media play by number, title, artist, date or length of time of play.

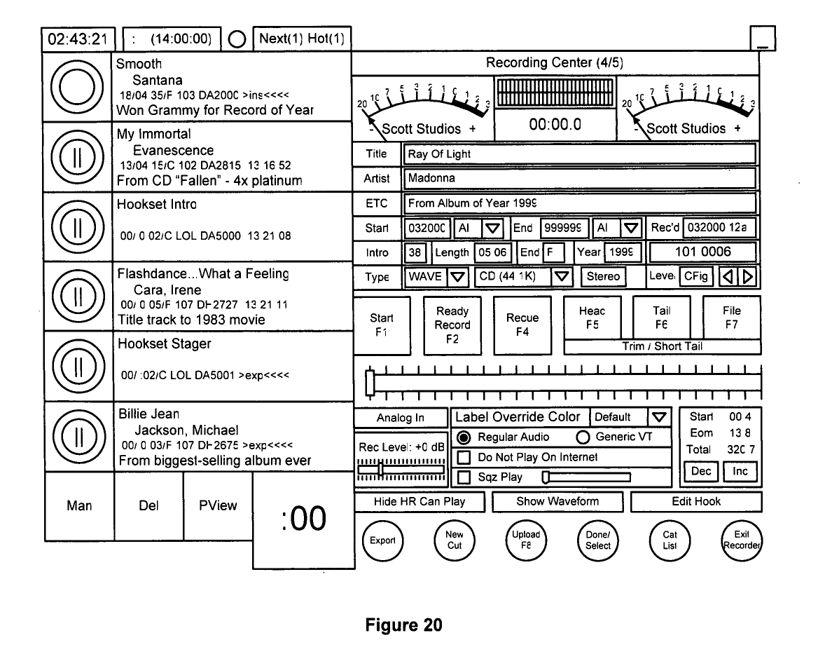

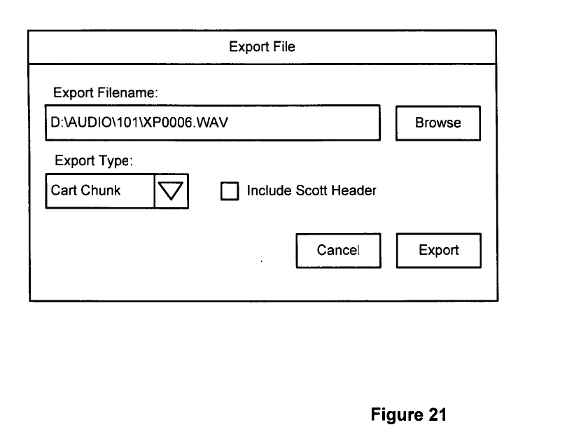

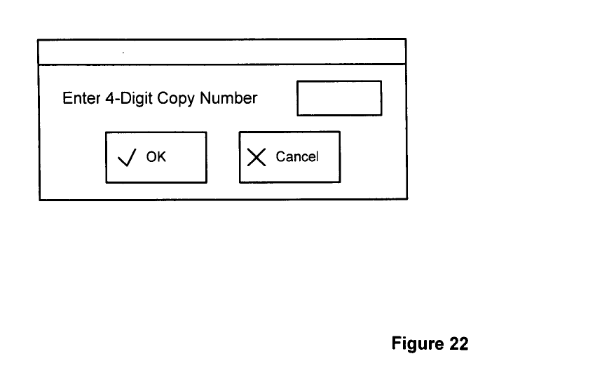

Further, each media play within the system may be tailored to the user's use. By way of non-limiting example only, if the first media play, as illustrated in FIG. 19 is double clicked, the user may be presented with the recording center as illustrated in FIG. 20. By way on non-limiting example only, during this intro time, a user may in the recoding center as illustrated in FIG. 20, record other audio on top of the 38 second intro. A media play loaded into the recording center may be exported by illustrated by FIG. 21, by clicking the “export” button in the recording center. A media file may be exported into multiple formats including a network file, for example. The recording center may also allow for a portion of a media play to be cut or otherwise re-portioned by clicking the “new cut” button from the recording center, providing the option to save the new cut by the user as illustrated in FIG. 22.

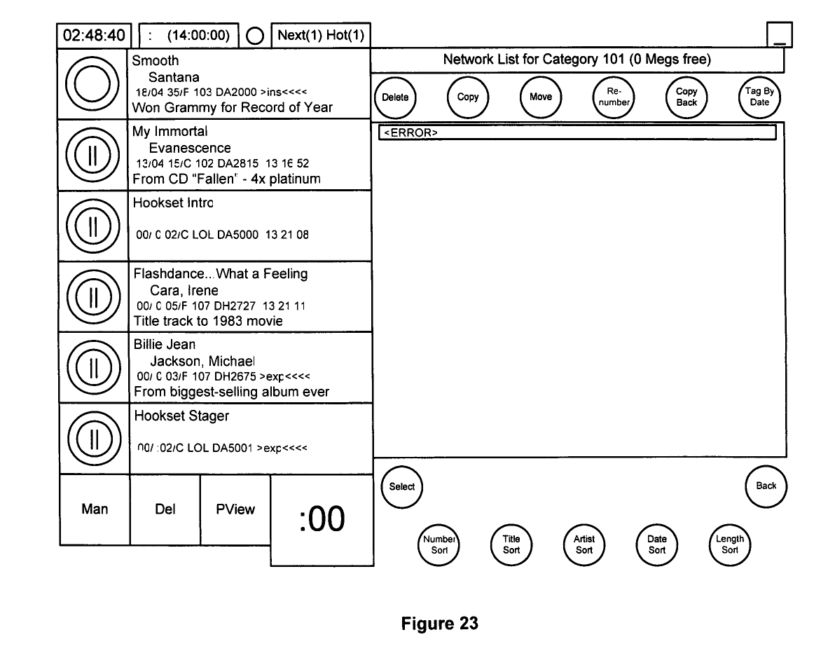

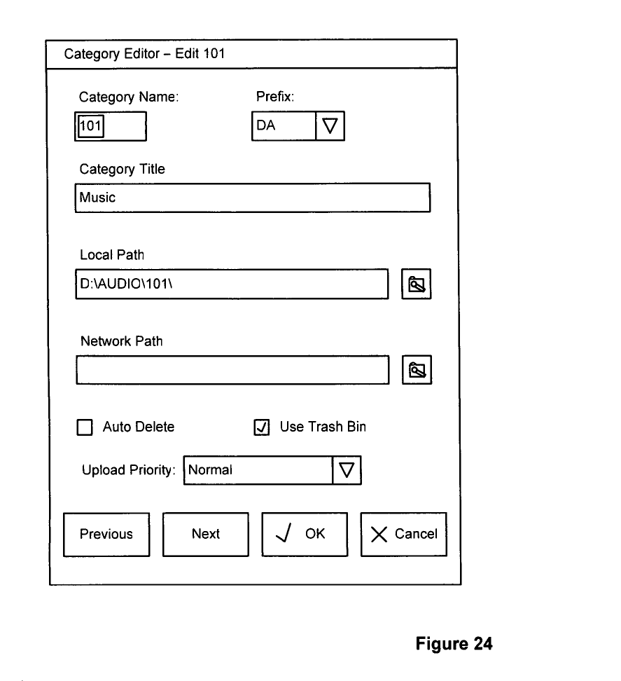

Referring again to FIG. 18, by clicking “new list”, the system may provide a network list for categories selected, such as, for example, a network list for category 101 as illustrated by FIG. 23. The network list may provide links to audio files within a particular category that are not located or are resident with the user. By way of non-limiting example only, a media file associated with category 101 may be located remote from the user and may be accessed through a network connection through the network list for category 101. Referring again to FIG. 18, clicking the “edit” button may allow the user of the system to edit certain information regarding the location of categories or carts, for example. By way of non-limiting example only, if category 101 is selected and the user chooses to edit that category, the window as illustrated in FIG. 24 may be provided. The edit window may allow a user to edit the category name, prefix, title and location, for example.

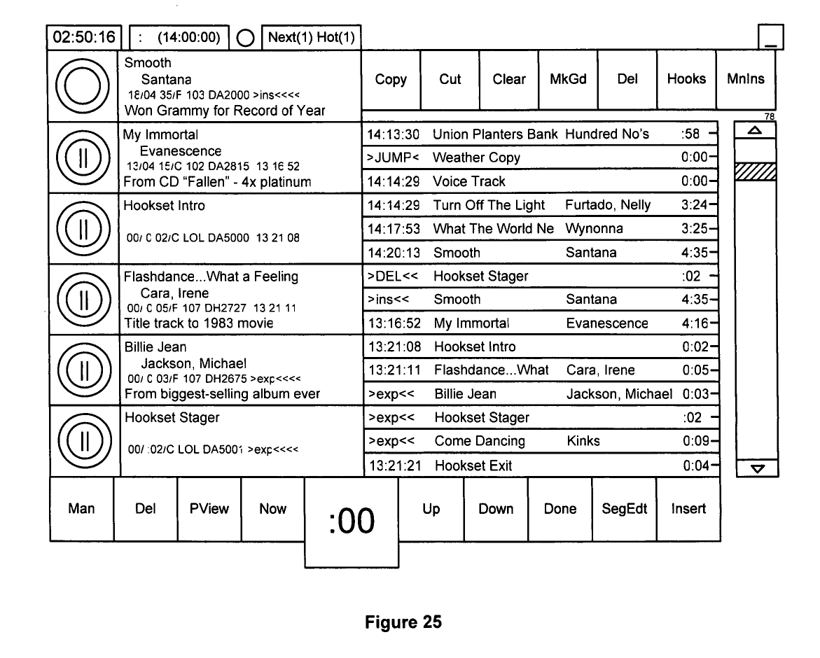

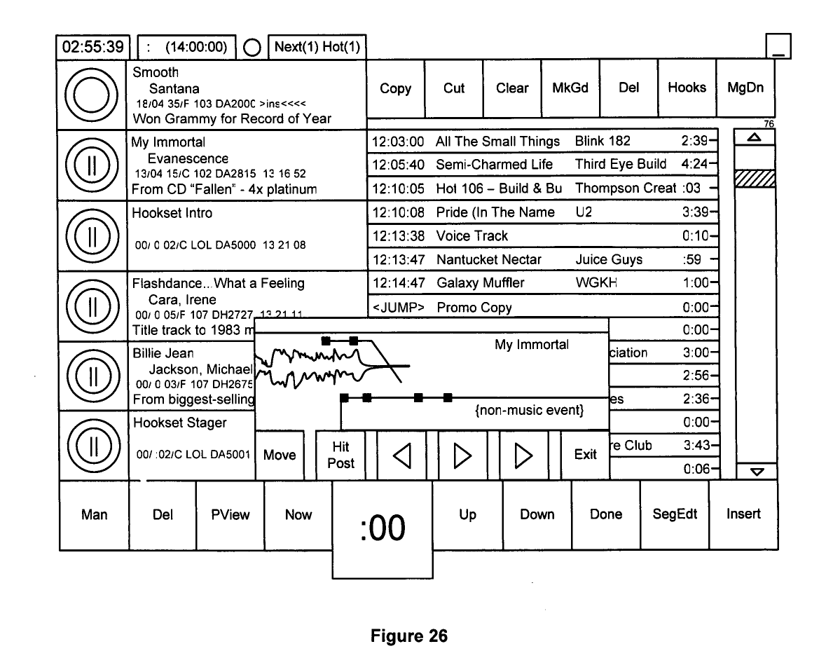

Referring back to FIG. 4, the user may select the “log” feature of the present invention. As illustrated in FIG. 25, the log may include the time of day the media was played, the date it was played upon, the title of the media and the length of time the media ran. For example, this log may be sorted by date, time and/or media authorship, for example. The log of the present system may include media plays that have already occurred, or may include a list of media plays that are presently playing or will be played in the future. Features that may be included in the log may include, for example, the ability to add hooks or advertising promos for continued listening and links to remote advertising materials not local to the user. The log may further provide the user the ability to edit a segment of an audio file as illustrated in FIG. 26. By clicking the “segment edit” button, the user may be presented with a window which may provide for the editing of the audio file. Further, the user may also insert media files from the system into the log list.

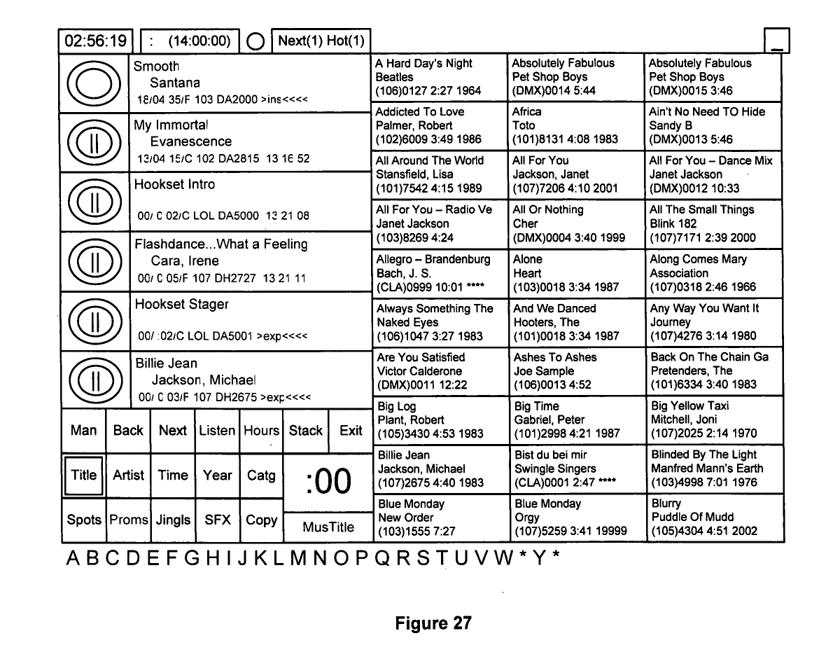

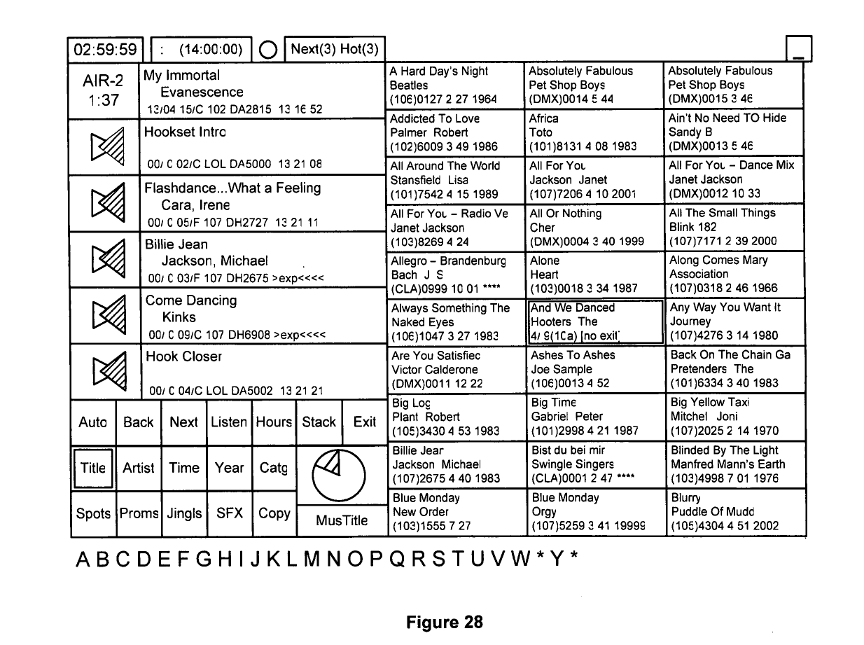

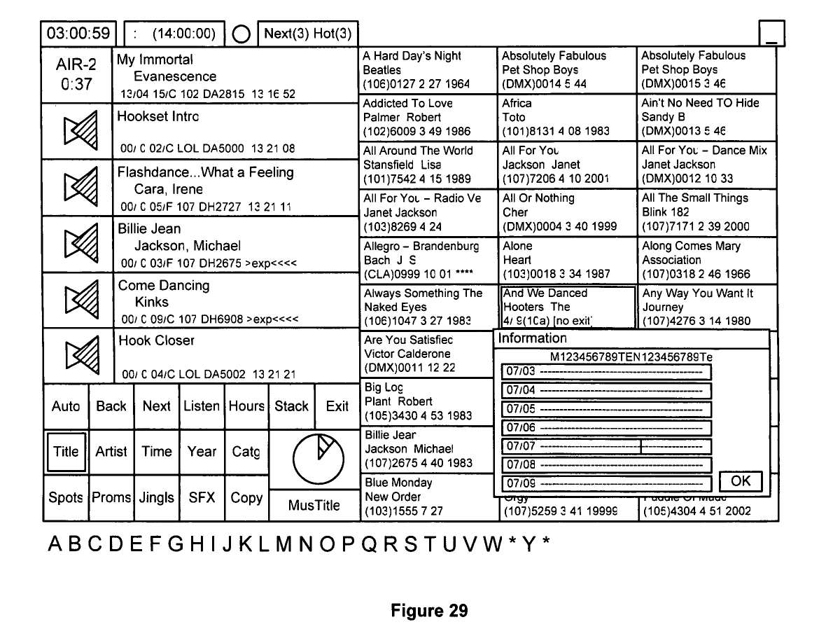

As illustrated in FIG. 27, a user may be presented with a listing of all media files within the system by clicking the “insert” button as illustrated in FIG. 26. The listing of all or a portion of all media plays contained within the system as illustrated in FIG. 27, may be done in many ways including alphabetically by title, alphabetically by artist, in descending order of run time, by type and year, for example. A song selected, may be added to the play list at any position as illustrated in FIG. 28. By way of non-limiting example only, if this song “And we danced” by the Hooters is selected to be inserted into the play list, insertion errors may appear in the play list. The user may then select or click a particular insertion symbol to insert the highlighted song into the play list at that desired position. Before insertion into the play list, the user may desire to know how often the selected media track has been played in the play list. While the song is selected, the user may select or click the “hours” button to be provided information regarding the amount of the track has been played in, for example, a given week as illustrated in FIG. 29.

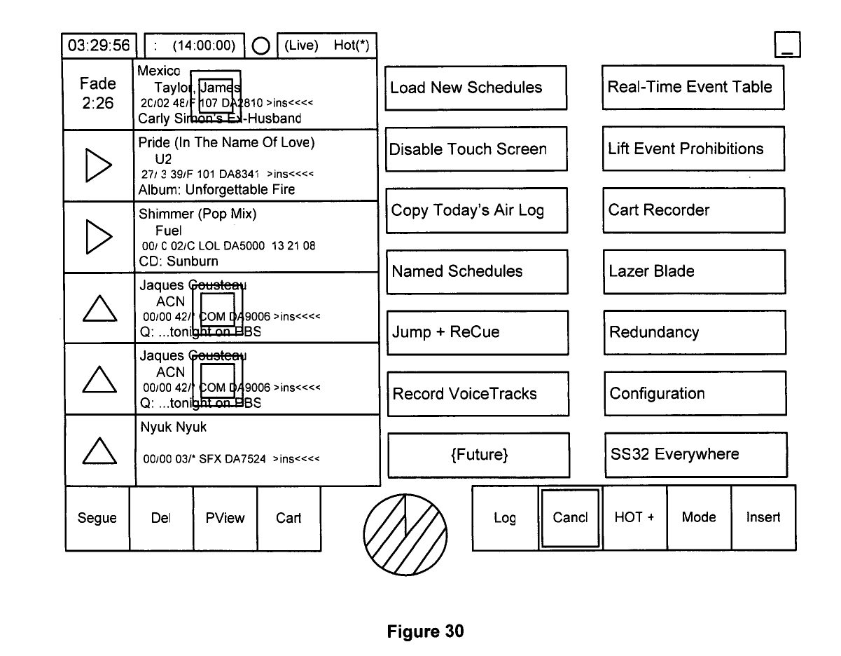

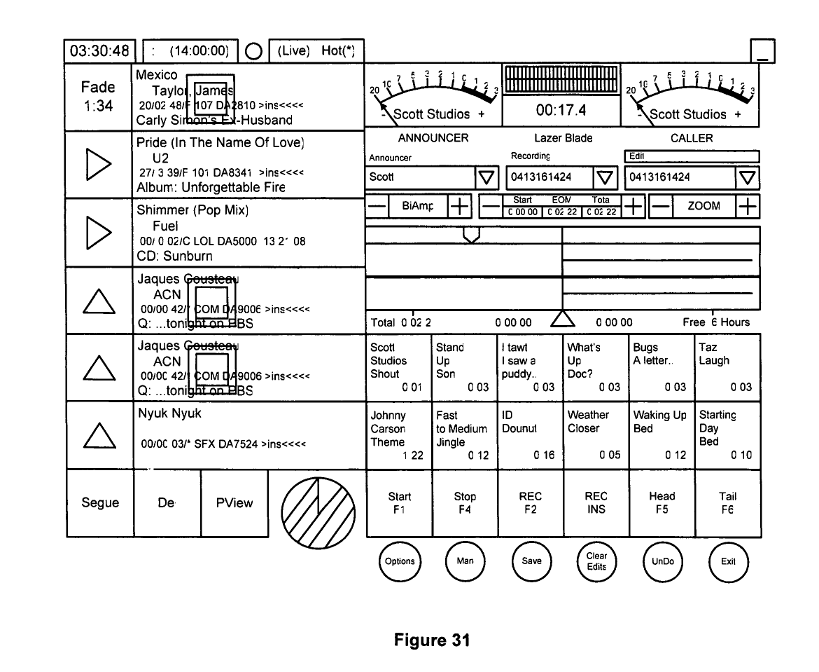

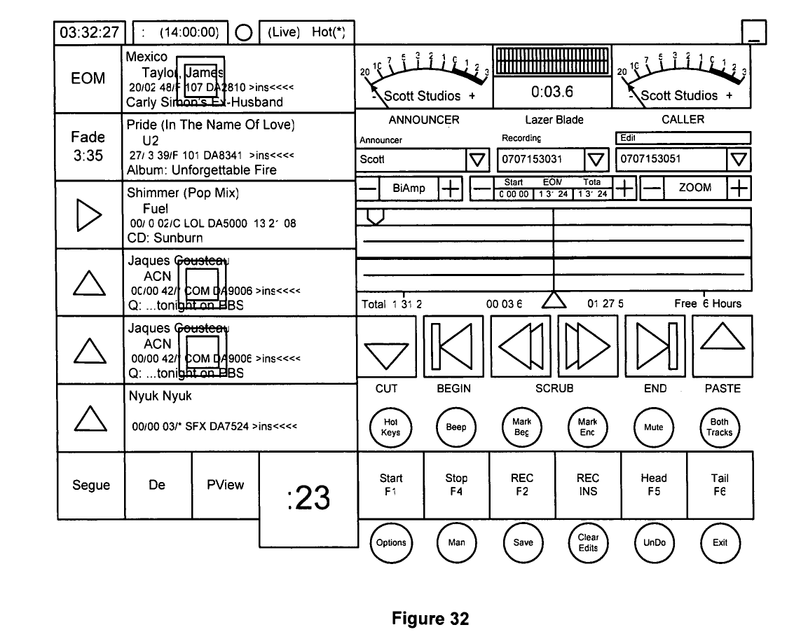

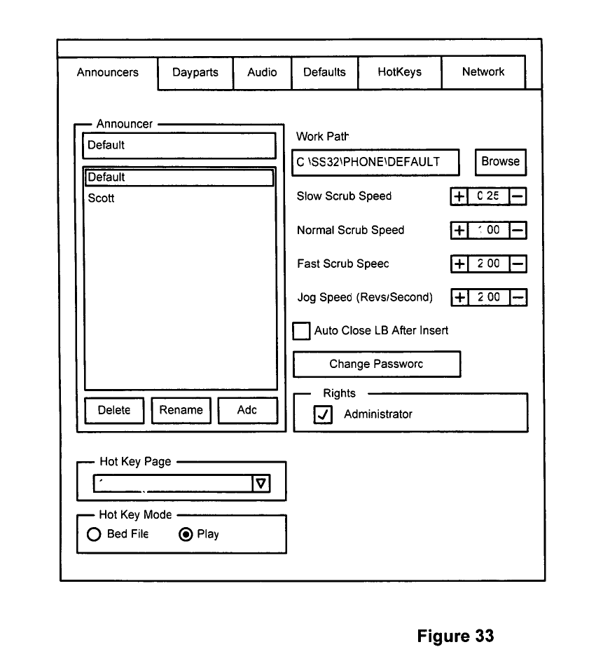

As illustrated in FIG. 30, options within the present system may include the ability to create schedules, create real time event tables, disable touch screens within the system, lift event prohibitions, copy logs, access a cart reporter, access named schedules, access a phone recorder, jump and re-queue media plays, access redundancy of media plays, record voice tracks, configure the system, and access network conductivity, for example. As more fully illustrated in FIG. 31, the system may provide for a phone recorder which may allow for the recording of any caller received by user of the system. The phone editor may set place markers while recording an incoming phone call so as to easily jump within the recording while editing. In addition, a user of the system and an incoming caller into the system may be reported on separate tracks which may allow the tracks to be locked and/or separated for editing. This functionality may further allow a user of the system to add effects, to play hot keys and/or re-record tracks during editing, as may be illustrated in FIG. 32. In addition, the phone recorder may also provide options related to recordings by the user or caller as illustrated in FIGS. 33 through 38.

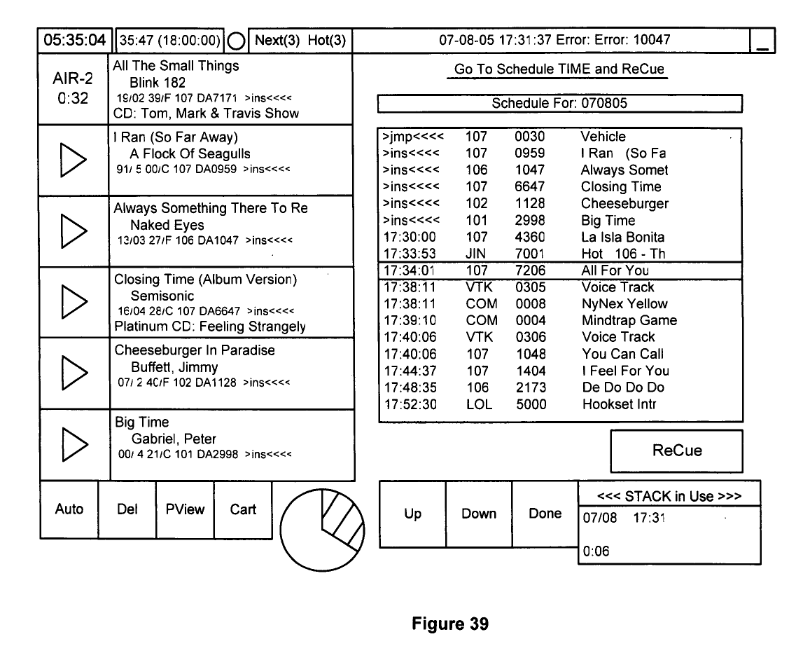

Referring back now to FIG. 30, a user may click the “jump+queue” button and be presented with the ability to re-queue media plays as illustrated in FIG. 39. The system may allow for a selection of previously played or scheduled to play media plays to be re-queued within the system.

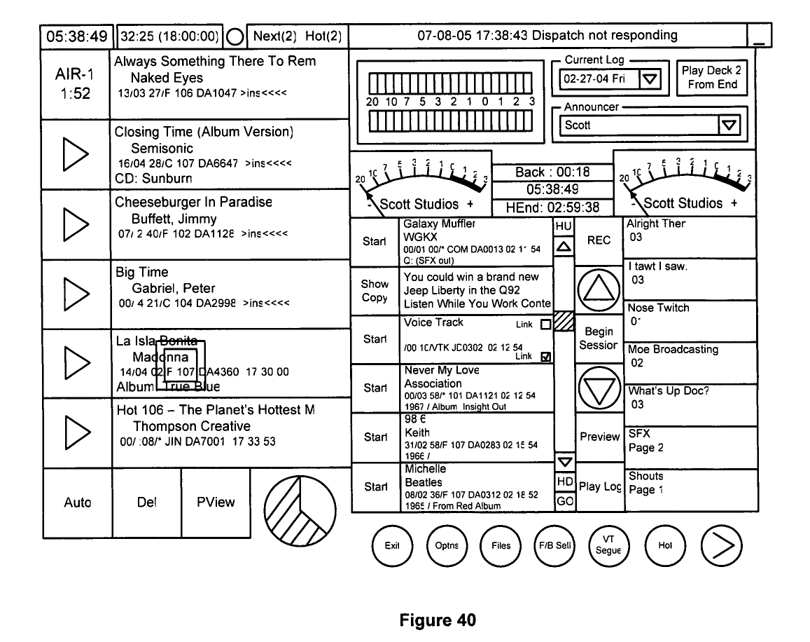

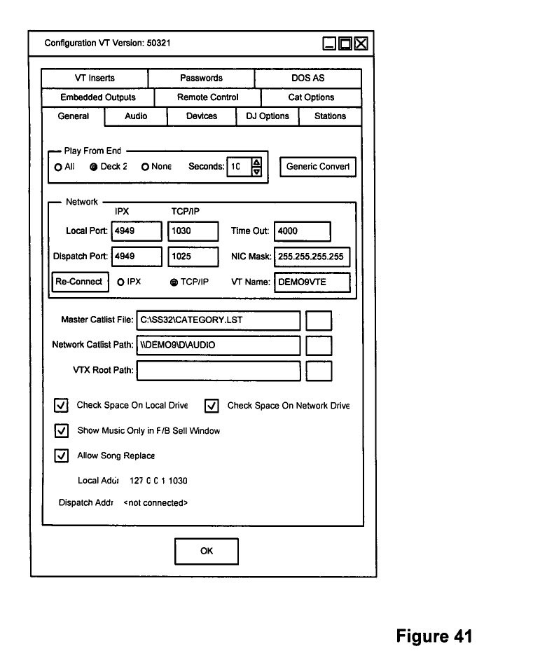

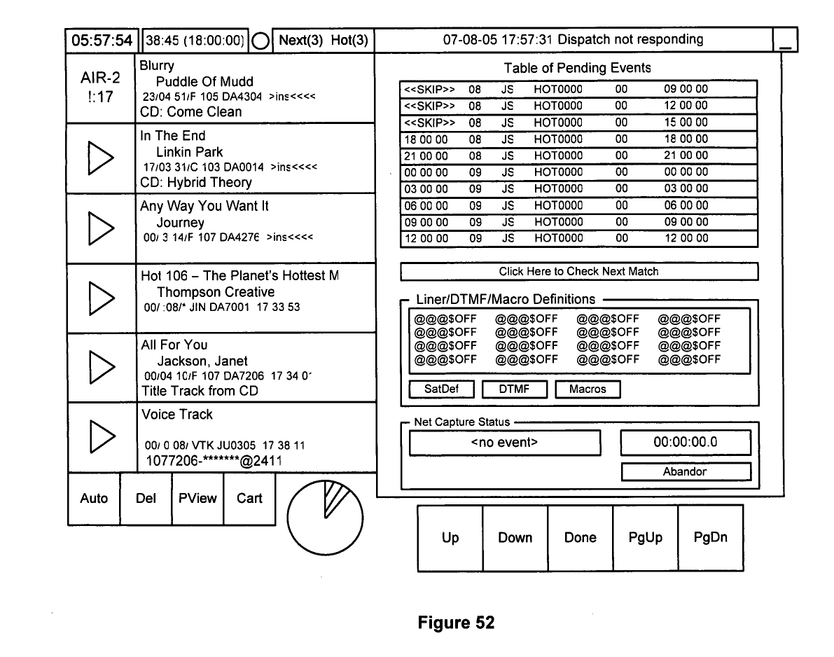

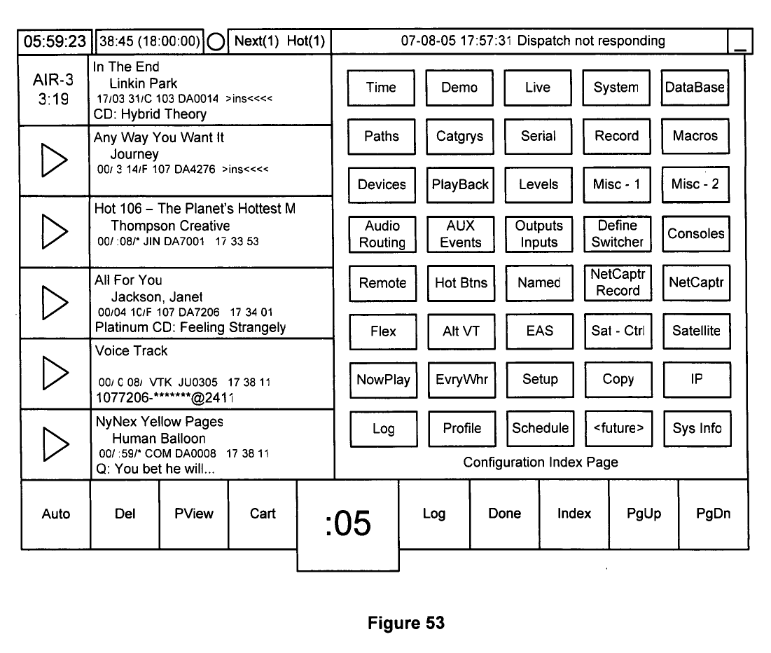

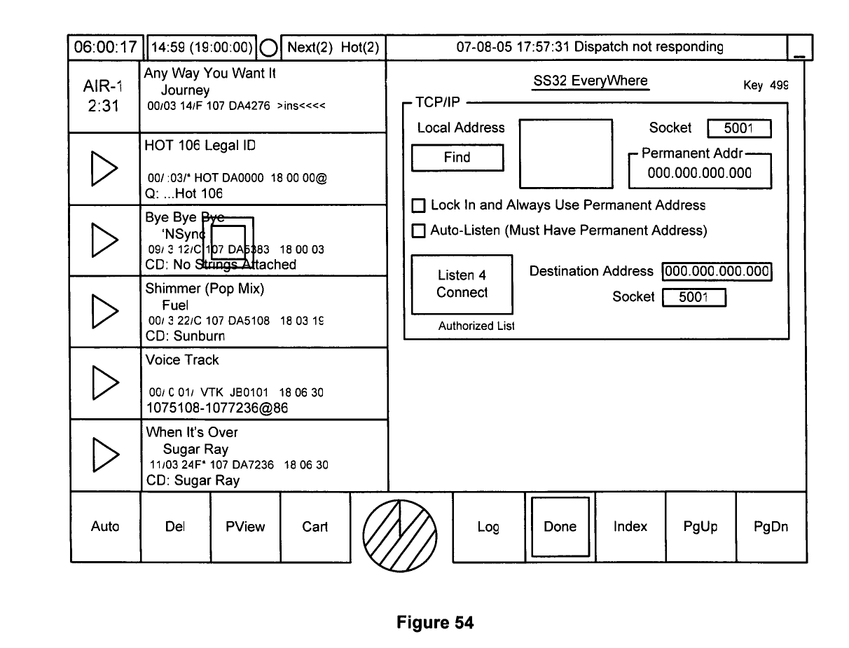

Referring again back to FIG. 30, if a user clicks the “record voice tracks” button, the user may be presented with functionality as illustrated in FIG. 40. This functionality of the system may allow a user to record his or her voice in conjunction with a variety of media play contained within the system. In addition, the system may provide the user with many options related to the recording of the user's voice such as those illustrated in FIGS. 41 through 51 and is described otherwise herein above. Again, referring back to FIG. 30, the present invention may provide for a real time event table as illustrated in FIG. 52, multiple configuration options as illustrated in FIG. 53, and network functionality as illustrated in FIG. 54.

Those of ordinary skill in the art may recognize that many modifications and variations of the present invention may be implemented without departing from the spirit or scope of the invention. Thus, it is intended that the present invention covers the modifications and variations of this invention provided they come within the scope of the appended claims and their equivalents.

1. A system for managing broadcasting of media content, comprising:
at least one database at a hub, wherein at least one digital file associated with said media content is relationally present in said at least one database;
a computer software accessible at a local media play point remote from said hub that provides a graphical user interface for at least scheduling, editing, and distributing of a plurality of ones of said at least one digital file for said broadcasting, wherein the interface comprises at least a header reader that allows for graphical display of header information, wherein the header information includes at least a graphic indicative of length of play and a plurality of alerts occurring within the length of play; and
at least one computerized device at said local media play point capable of accessing said at least one digital file based on instructions entered to said computer software via said graphical user interface for play over said local media play point.

2. The system of claim 1, wherein said play over said local media play point is at least partially automated.

3. The system of claim 1, wherein said computer software further comprises a recording mechanism.

4. The system of claim 1, wherein said computer software inserts at least one generic track to fill a schedule gap.

5. The system of claim 1, wherein said computer software incorporates an external feed into said plurality of ones of said at least one digital file for distributing.

6. The system of claim 1, wherein said broadcasting is an internet broadcasting.
